(19) United States
(12) Patent Application Publication
(10) Pub. No.: US 2026/0287969 A1
(43) Pub. Date: Sep. 24, 2026

(54) OPTOELECTRONIC NEURON ARRAY FOR NONLINEAR OPTICAL MODULATION

(71) Applicant: THE REGENTS OF THE UNIVERSITY OF CALIFORNIA, Oakland, CA (US)

(72) Inventors: Xiangfeng Duan, Los Angeles, CA (US); Aydogan Ozcan, Los Angeles, CA (US); Dehui Zhang, Los Angeles, CA (US)

(73) Assignee: THE REGENTS OF THE UNIVERSITY OF CALIFORNIA, Oakland, CA (US)

(21) Appl. No.: 19/475,967

(22) PCT Filed: Apr. 23, 2024
(86) PCT No.: PCT/US2024/025878

§ 371 Date: Oct. 16, 2025

Related U.S. Application Data
(60) Provisional application No. 63/497,969, filed on Apr. 24, 2023.

(51) Int. Cl. G02F 1/35; H04N 23/75; H04N 23/95

(52) U.S. Cl. CPC G02F 1/3503; H04N 23/75; H04N 23/95

(57) ABSTRACT

An optoelectronic neuron array device is disclosed that merges 2D transparent phototransistors (TPTs) with liquid crystal (LC) modulators. The device allows self-amplitude modulation of spatially incoherent light, achieving a large nonlinear contrast over a broad spectrum at orders-of-magnitude lower intensity than achievable in most optical nonlinear materials. A 10,000-pixel array of optoelectronic neurons was fabricated and an intelligent imaging system was experimentally demonstrated that instantly attenuates input glares while retaining the weaker-intensity objects captured by a cellphone camera. This intelligent glare-reduction is important for various imaging applications, including autonomous driving, machine vision, and security cameras. The rapid nonlinear processing of incoherent broadband light also finds applications in optical computing, where nonlinear activation functions for ambient light conditions are highly sought.

### RELATED APPLICATION

This application claims priority to U.S. Provisional Patent Application No. 63/497,969 filed on Apr. 24, 2023 which is hereby incorporated by reference. Priority is claimed pursuant to 35 U.S.C. § 119 and any other applicable statute.

### TECHNICAL FIELD

The technical field generally relates to an optoelectronic nonlinear filter array that exhibits a strong optical nonlinear response under relatively weak broadband incoherent light illumination.

### BACKGROUND

General-purpose optical computing and computational imaging would significantly benefit from optical nonlinearity. For various practical applications involving the processing of visual information and scenes, the nonlinear optical layer must operate at low optical intensities and high frame rates, covering spatially incoherent broadband illumination. Furthermore, energy loss through the nonlinear layers should be minimal to preserve the information carried by the optical fields. These demanding requirements on high speed, large nonlinear coefficient, low threshold intensity, low loss, and broadband response can hardly be achieved with existing nonlinear optical materials. For example, the ambient light intensity captured by digital cameras is typically below ~0.1 W/cm², which is many orders of magnitude weaker than the intensities employed in typical nonlinear optical processes, such as second harmonic generation (>1011 W/cm²), ultrafast nonlinear absorption (>10⁶ W/cm²), and nonlinear Kerr effect (>10⁴ W/cm²). Alternative forms of nonlinearity, such as photochromic and photorefractive effects, may also be used, but these processes are typically slow, involving response time scales on the order of a few to tens of seconds. Other forms of photorefractive effect, for example, in multiple quantum wells, are fast but present very weak nonlinearity. Some organic photorefractive devices show millisecond responses, but rely on coherent interference to build up spatial charge patterns and create strong nonlinear diffraction patterns, and are thus mostly adapted to holography. Many of these photochromic or photorefractive devices also feature strong absorption (e.g., >90%), leading to substantial optical losses. Additionally, most of the existing nonlinear optical processes work for only a limited wavelength range.

Ultimately, the challenge lies in the fundamental tradeoff among power, speed, and transparency. Strong nonlinear responses require significant photo-induced physical/chemical changes in the material. This is achieved in typical photochromatic/photorefractive devices by either absorbing a sufficient number of photons in a short time interval, which either requires intense illumination far beyond the intensity of natural light or strong optical absorption that leads to low transparency and substantial losses; or capturing a smaller portion of photons and gradually accumulating the photo-induced changes over a longer period, which is more transparent but with an intrinsically slow response. Addressing these challenges requires a fundamentally distinct working mechanism that can use a small amount of optical power to strongly modulate the incoming photons.

### SUMMARY

In one embodiment, an optoelectronic neuron array is disclosed that achieves strong optical nonlinearity at low optical intensity, enabling broadband nonlinear modulation of incoherent light. This nonlinear optoelectronic neuron array is created by the heterogeneous integration of two-dimensional (2D) transparent phototransistors (TPTs) with liquid crystal (LC) cells or modulators. The designed optoelectronic neurons allow spatially and temporally incoherent light in the visible wavelengths to tune its own amplitude with only ~20% photon loss. For a proof-of-concept demonstration, a 100×100 (10,000) optoelectronic neuron array was fabricated and a strong nonlinear behavior was demonstrated under laser and white light illumination. The nonlinear filter-array was further integrated as part of a cellphone-based imaging system for intelligent glare reduction, selectively blocking intense glares with little attenuation of the weaker-intensity light from objects within the field of view. Device modeling suggests a very low optical intensity threshold of 56 μW/cm² to generate a significant nonlinear response, and a low energy consumption of 69 fJ per photonic activation after proper device optimization. The results demonstrate a new type of 2D optoelectronic device for nonlinear processing of low-power broadband incoherent light, which is highly desirable for image processing and visual computing systems that do not rely on intense laser inputs. When coupled with free-space optical computing systems, composed of, for example, task-specific diffractive processors, the optical inputs to this nonlinear optoelectronic neuron array can take programmable convolutional or fully-connected filters, covering any desired set of spatially varying point spread functions between the visual scene and the plane of the optoelectronic device. Therefore, cascaded integration of optoelectronic neuron arrays with linear diffractive processors could be used to construct nonlinear optical networks, potentially finding widespread applications in computational imaging and sensing, also opening the door for new nonlinear optical processor designs using ambient light.

In one embodiment, an optoelectronic neuron array device for nonlinear optical modulation having an array of pixels, each pixel including: a two-dimensional transparent phototransistor (TPT) having a source electrode, a drain electrode, and a channel. A liquid crystal (LC) cell is disposed adjacent to the TPT and includes a top optically transparent ground electrode. An intermediate optically transparent electrode is interposed between the TPT and the LC cell and wherein the source electrode of the TPT is electrically connected to the intermediate optically transparent electrode and wherein the drain electrode of the TPT is electrically connected to a supply voltage (V_{dd}). The supply voltage (V_{dd}) powers each pixel within the array in parallel.

In another embodiment, a method of performing nonlinear modulation of broadband, incoherent light includes providing an optoelectronic neuron array device for nonlinear optical modulation having an array of pixels, each pixel includes a two-dimensional transparent phototransistor (TPT) having a source electrode, a drain electrode, and a channel; an intermediate optically transparent electrode; and a liquid crystal (LC) cell disposed adjacent to the TPT and including a top optically transparent ground electrode, wherein the intermediate optically transparent electrode is interposed between the TPT and the LC cell and wherein the source electrode is electrically connected to the intermediate optically transparent electrode and wherein the drain electrode is electrically connected to a supply voltage (V_{dd}). A supply voltage (V_{dd}) is applied to drain electrodes of each pixel and the broadband, incoherent light is input into the optoelectronic neuron array. The incident light passes first through the TPT followed by the LC cell. The transmittivity of the light through the LC cell is nonlinearly modulated based on the intensity of the incident light on the optoelectronic neuron array.

The output (e.g., image) of the optoelectronic neuron array may be captured with image capture device such as a camera, microscope, or other imaging device that includes an image sensor or optical detector(s). In some embodiments, the optoelectronic neuron array may be integrated with one or more optical or diffractive neural networks. For example, the optical or diffractive neural networks may include linear modulators integrated with the nonlinear modulation effectuated by the optoelectronic neuron array. This may include, for example, an optical processor.

The optoelectronic neuron array may also be used with one or more optical or diffractive neural networks arranged in an optical path with the optoelectronic neuron array. The optical or diffractive neural network includes optically transmissive and/or reflective substrate layer(s) having a plurality of physical features formed on or within the one or more optically transmissive or reflective substrate layer(s) and having different transmission and/or reflection properties as a function of the lateral coordinates across each substrate layer, wherein the one or more optically transmissive and/or reflective substrate layer(s) arrays collectively process and/or extract and/or reject object and/or scene information from an input image input to the optically transmissive and/or reflective substrate layer(s).

### BRIEF DESCRIPTION OF THE DRAWINGS

FIG. 1A illustrates a photograph of the finished transparent optoelectronic neuron array (marked by the solid box/square in array, polarizers not included). The 100×100-pixel array covers 1 cm×1 cm area.

FIG. 1B is a schematic representation of an optoelectronic neuron array with all neurons connected to the common V_{dd} and GND electrodes (e.g., top electrode). A globally wired metal electrode is fabricated with lithography and applies V_{dd} to all pixels in parallel.

FIG. 1C illustrates the equivalent circuit of the neuron pixels sharing common V_{dd} and GND. The arrows represent the local incident light.

FIG. 1D schematically illustrates the self-amplitude modulation of light in the TPT-LC optoelectronic neuron array by several pixels in response to illumination with different intensities of light. Under low light illumination (left most pixel), the TPT is highly resistive, most voltage drop occurs on the TPT. Thus, the voltage drop and electrical field across the LC are small (thin dashed line represents a weak field). The LC is unperturbed and remains transmissive. The equivalent circuit is shown on the left side, where the TPT is highly resistive. At high input optical power, the TPT becomes conductive (marked in the equivalent circuit on the right side), so most voltage drops across the LC layer (thick solid arrow E represents a strong field), shutting off or strongly attenuating the optical transmission.

FIG. 1E illustrates a schematic illustration of a single-pixel structure disassembled by layers. The light is incident from the bottom in this orientation, passing through the first polarizer and then through a glass substrate and a TPT made with MoS₂ VDWTF. An SU-8 insulating layer isolates an ITO electrode from the TPT channel. The ITO electrode is only locally connected to a single TPT and isolated from nearby pixels. The liquid crystal molecules are anisotropic, rendered as ellipsoids in FIG. 1E. The molecules gradually rotate their 3D orientations to form a spiral pattern, rotating the incident light's polarization. A polyvinyl alcohol (PVA) alignment layer controls the LC molecule orientation at the PVA-LC interface. Another orthogonal alignment layer is on top of the LC layer, so the LC molecules gradually twist in the cell. Electrical current flows through the TPT to the ITO layer in the middle, then to the top ITO layer, which is grounded. The LC cell also works as an optically inactive resistor.

FIG. 2A is a photograph of a 10 cm×10 cm glass substrate coated with the MoS₂ VDWTF, demonstrating large-area scalability and transparency. Scale bar: 2 cm.

FIG. 2B is a microscopic image of the TPT array. The gold wires are connected directly to V_{dd}. The vias (the small gold spots) connect to the ITO electrode covering the entire pixel area. Scale bar: 500 μm. The contrast is large despite the high transparency of the device since the microscope works in reflection mode.

FIG. 2C illustrates the transmission spectrum of the VDWTF in the visible range (identified by dashed lines).

FIG. 2D illustrates the photocurrent of a separately wired-out TPT at sweeping source-drain bias under 633-nm laser in the direction of arrow A: under the illumination intensity of 0, 0.7, 6.0, 65.8, 220, 393, 531, 1740, 3140, and 5920 mW/cm², respectively. Inset: the ratio of the channel current over dark current at different optical intensities.

FIG. 2E is a graph showing the responsivity measured by a lock-in amplifier at different laser chopping frequencies. Diamonds: data from a 488-nm laser at 0.46 mW (4.6 W/cm²) on a single pixel; Circles: data from a 633-nm laser at 0.59 mW (5.9 W/cm²). Vertical lines indicate the extrapolated 3 dB cutoff frequencies at 3.5 kHz and 4.7 kHz, respectively, which are above the chopping frequency available in the laboratory.

FIG. 2F illustrates the ratio of the dark resistances over the light resistances of 116 TPTs, with a dark/light resistance ratio of 9.0±1.3 (mean and standard deviation). The channel bias was 1 V for FIGS. 2E and 2F.

FIG. 3A illustrates the dependence of the transmission ratio on the incident power density of a 473 nm laser illumination under different voltage supplies. The two polarizers are orthogonal in this configuration.

FIG. 3B illustrates the opposite nonlinear behavior at 473 nm when the two polarizers are parallel.

FIG. 3C illustrates nonlinear behavior with 650-nm laser illumination under orthogonal polarizer orientations at V_{dd}=8 V. The result with 473 nm laser in FIG. 3A is also plotted for comparison.

FIG. 3D is a histogram of the transmission ratio value distribution of 99 individual TPT-LC pixels at weak (orange, 0.77±0.04, mean and standard deviation) and intense (red, 0.39±0.09) white LED illumination (at V_{dd}=8 V with orthogonal polarizers). The transmission ratios are normalized by the transmission state at V_{dd}=0 V (see Methods). Inset: the mean value and standard deviation of transmission estimated over different illuminance values. The incident laser in FIGS. 3A-3C was polarized along the polarizer (P1—first polarizer) direction. All data were measured on the same chip, with slight threshold deviations due to pixel-to-pixel variations.

FIG. 4A illustrates a photograph of the optical setup for the glare reduction test. White light from an LED array is diffusely reflected by an unpolished aluminum foil diffuser (D) and transmits through a patterned gold mask as the object (Obj). The pattern is imaged by the lens L1 on the image plane that overlaps with the optoelectronic neuron layer (NL). The light then passes through L2, which works as a magnifying system to adjust the field of view and the depth of field at the cellphone camera (Cam). An attenuator (Attn) adjusts the captured light intensity. The laser (ray) is reflected by the gold mask to create a bright glare.

FIG. 4B illustrates the raw image (left) taken by the cellphone without glare at V_{dd}=0 V. The average intensity (solid lines) and the noise levels (error bars) in the boxes are plotted in the five panels/boxes on the right.

FIG. 4C illustrates the raw image (left) and results with laser-induced glare with a total glare power of 100 μW, measured by placing a power meter in front of L1. The camera settings are identical to FIG. 4B, V_{dd}=0 V.

FIG. 4D illustrates the raw image (left) and results with glare, V_{dd}=6 V.

FIG. 4E illustrates the raw image (left) and results with glare. The auto-exposure of the cellphone camera is turned on. V_{dd}=0 V.

FIG. 4F illustrates the raw image (left) and results with glare. The auto-exposure is turned on. V_{dd}=6 V.

FIG. 5A illustrates images taken of the optoelectronic neuron at V_{dd}=6 V with a fixed exposure. The laser glare is suddenly turned off between the first frame (0 ms) and the second frame (~17 ms). Curves on the right (for FIGS. 5A-5F): the intensity averaged over all pixels in the displayed area (darker lines) and averaged in the box area shown in (lighter lines) of each frame, plotted with respect to time. The glare power and optical setup are identical to FIG. 4A.

FIG. 5B illustrates images taken of the optoelectronic neuron at V_{dd}=0 V and fixed exposure as the glare is turned off between the first two frames.

FIG. 5C illustrates images taken of the optoelectronic neuron at V_{dd}=0 V and auto-exposure.

FIG. 5D illustrates images taken of the optoelectronic neuron at V_{dd}=6 V and fixed exposure as the laser glare is turned on between the first two frames.

FIG. 5E illustrates images taken of the optoelectronic neuron at V_{dd}=0 V and fixed exposure.

FIG. 5F illustrates images taken of the optoelectronic neuron at V_{dd}=0 V and auto-exposure. Curves on the right: the intensity averaged over all pixels in the displayed area (darker lines) and averaged in the red box area shown in a (lighter lines) of each frame, plotted with respect to time. The glare power and optical setup are identical to FIG. 4.

FIG. 6A illustrates the as-fabricated MoS₂ ink with nanosheets dispersed in IPA and held within a container.

FIG. 6B illustrates the AFM measurement on the VDWTF. Scale bar: 1 μm.

FIG. 6C illustrates the height profile along the thin white cutline in FIG. 6B, with a thickness around 9.4 nm.

FIG. 6D illustrates the Raman spectra of the VDWTF with an excitation wavelength of 633 nm. Solid line: mean value of 10-by-10 sampling points over a region of 1 mm. The error bars are defined with the standard deviation over 100 sampling points.

FIG. 6E illustrates the

$${E}_{2 g}^{1}$$

(Γ) peak intensity distribution over the 100 sampling points, with inter-pixel spacings at 100 μm.

FIG. 6F illustrates the A_{1g} (Γ) peak intensity distribution.

FIGS. 6G and 6H illustrate core level XPS spectra of MoS₂ VDWTF with fitting for Mo 3d (FIG. 6G), S 2s (FIG. 6G), and S 2p (FIG. 6H), respectively. The stoichiometric molar ratio Mo:S is 1:2.02, close to the theoretical expectation within the measurement error, suggesting satisfactory crystal quality and a low defect density.

FIG. 7A illustrates the transfer curve of a VDWTF field effect transistor fabricated on a 50-nm Al₂O₃ back gate. The device is fabricated with an identical process to the TPT. The source-drain bias is 1 V. The slope leads to a derived transistor mobility of 25 cm²/(V·s). The value is consistent with previously reported values of >10 cm²/(V·s).

FIG. 7B illustrates the photo response from a time sweep at 5-Hz chopping frequency. The observed rise and fall times are slower than the actual response time due to the lower sampling rate and the slow speed of the chopper edges as they cut through the laser beam diameter. The measurement conditions are identical to FIG. 2E.

FIG. 7C illustrates the extracted responsivity and ON/OFF ratio of a VDWTF FET fabricated on a silicon substrate with 300 nm SiO₂ body gate. V_{ds}=1V. The photocurrent was tested under a thermal lamp illumination at 10⁴ lux.

FIG. 7D illustrates the calculated voltage that is applied on the LC modulator (V_{LC}) with different TPT-LC resistance ratios. For the middle curve, V_{LC} is below the nonlinear threshold at low intensities, but increases at higher incident intensity, which enables a strong nonlinearity. The bottom curve does not enter the nonlinear region until very high intensities. The top curve is already in the middle of the threshold at low intensities, producing lower transmittance even under weak illumination. Gate tuning can change

$${R}_{TPT}^{( dark )}$$

to achieve a better resistance match, which leads to a larger V_{LC} shift across the threshold voltage range, leading to a stronger nonlinearity.

FIG. 7E illustrates V_{LC} under different gate biases (V_{g}). Matched resistances were assumed

$$( {R}_{TPT}^{( dark )} = {R}_{LC} )$$

with different V_{g}. V_{g}=−60 V decreases the dark current, hence creating a larger ON/OFF ratio and larger V_{LC} shift across the threshold voltage range (dashed lines) under illumination.

FIG. 7F is the equivalent circuit used to model the LC voltage in FIGS. 7D and 7E, with V_{dd}=6 V for both cases.

FIG. 8A illustrates measured amplitude modulation of weak thermal lamp light with pure LC. The transmission is normalized by its value at 0 V.

FIG. 8B illustrates extracted amplitude and phase modulation under weak light illumination. Data from a TPT-LC device different from the main device. The device also shows a lower threshold voltage due to variations in TPT resistance as a result of process variation.

FIG. 9 illustrates the schematic of the optical setup (see also FIG. 4A). The optical path of white light is shown in dashed lines, and the 473-nm laser path is highlighted in solid lines. The LED produces up to 1-W illumination that is diffusely reflected by the unpolished aluminum foil as the diffuser. The reflected light transmits through a patterned gold mask used as the object. Then, the pattern is imaged by lens L1 to the image plane that overlaps with the nonlinear layer NL. Lastly, the light passes through L2, which works as a magnifying system to facilitate better capture of the image at the smartphone camera. The laser beam is reflected by mirrors M1 and M2 to the metal mask surface. M1, M2, and mask angles are tuned to collimate the laser beam with the white light path.

FIG. 10 illustrates the LED spectrum (left), with a center wavelength of 582 nm along with the thermal lamp spectrum (right) at the power level applied during the measurement, with the center wavelength at 713 nm.

FIG. 11A illustrates the equivalent circuit for frequency response modeling.

FIG. 11B illustrates an estimation of the power consumption per unit area at different φ values. A: electrical power consumption; B: photon loss; C: total power consumption.

$${R}_{TPT}^{( D )}$$

~10 GΩ is the resistance of the MoS₂ channel in darkness, which was deduced from Eq. S1 from experimental data. The DC resistance of the LC layer, together with the LC alignment layers between the two ITO electrodes, is measured to be around 10 GQ per 100 μm×100 μm pixel with LC samples with identical fabrication process but with no TPT layers. The capacitance of the liquid crystal layer and its alignment layer (C) is calculated from experimental relative permittivity and device geometry parameters to be 71 fF/pixel.

FIG. 12 illustrates an exemplary embodiment of integrating the optoelectronic neuron array with one or more optical or diffractive neural networks. In this embodiment, a source of illumination illuminates an object with light which then passes along an optical path through a first optical or diffractive neural network then through the optoelectronic neuron array followed by a second optical or diffractive neural network with the output image or optical signal being captured by an image capture device (e.g., image sensor). Optional lenses are located along the optical path. This embodiment shows a linear-nonlinear-linear configuration.

FIG. 13 illustrates a single substrate layer used in optical or diffractive neural network. Physical features are located along the length and width of the substrate layer which alter the transmissive or reflective properties of light interacting with the substrate layer. In one example, the physical features may include varied thicknesses of the substrate layer which alter the transmission parameters/coefficients along the surface of the substrate layer.

FIG. 14 illustrates one embodiment of glasses or goggles that utilize the optoelectronic neuron array to reduce glare.

FIG. 15 illustrates one exemplary configuration of an AI camera system that incorporates an optoelectronic neuron array. Optical information is processed with linear optical or diffractive layers and nonlinear activation by the optoelectronic neuron array before reaching the image capture device such as an image sensor (e.g., CCD or CMOS array). The high-speed, low energy-consumption pre-processing would allow a variety of unique imaging and sensing applications.

### DETAILED DESCRIPTION OF ILLUSTRATED EMBODIMENTS

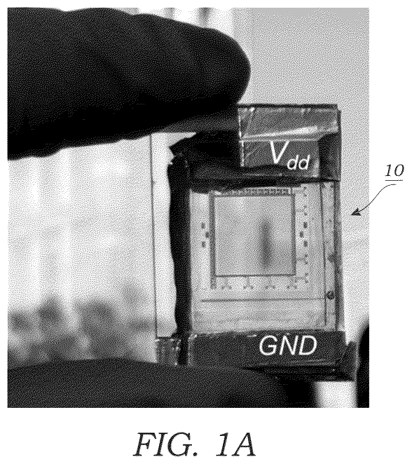

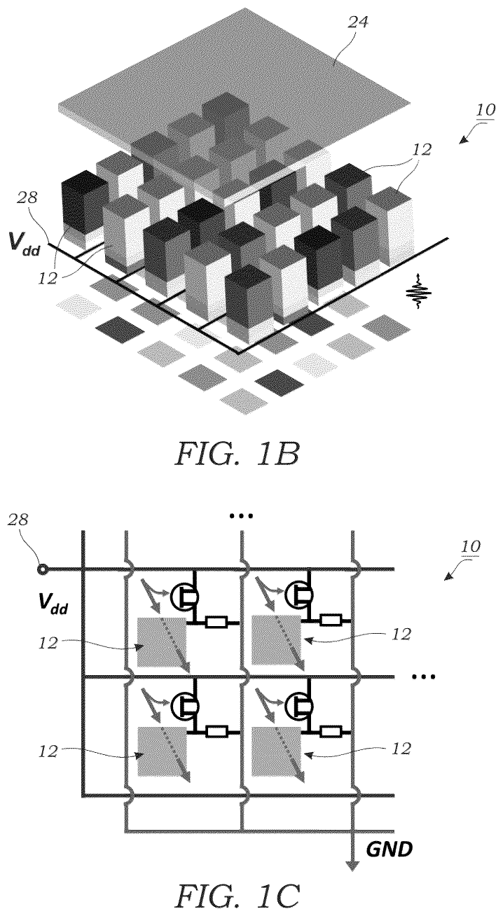

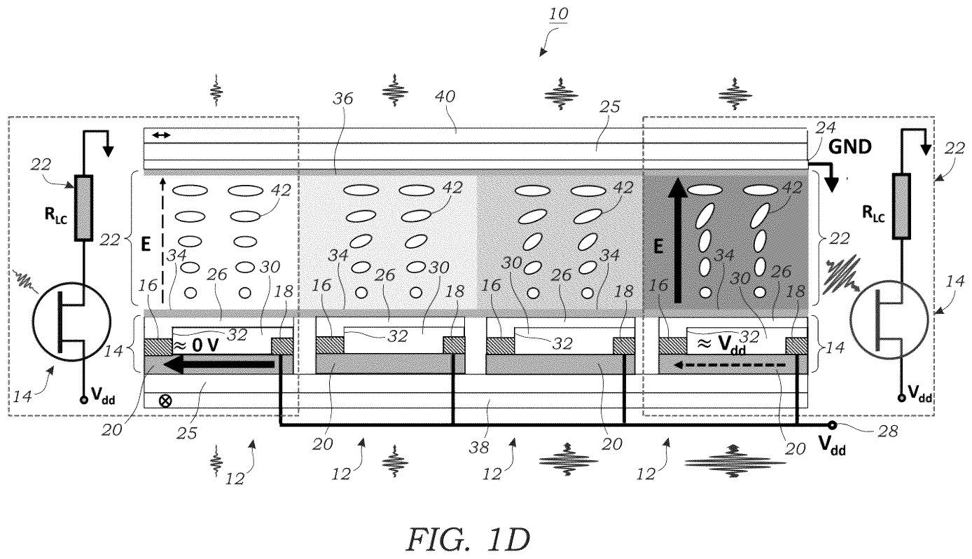

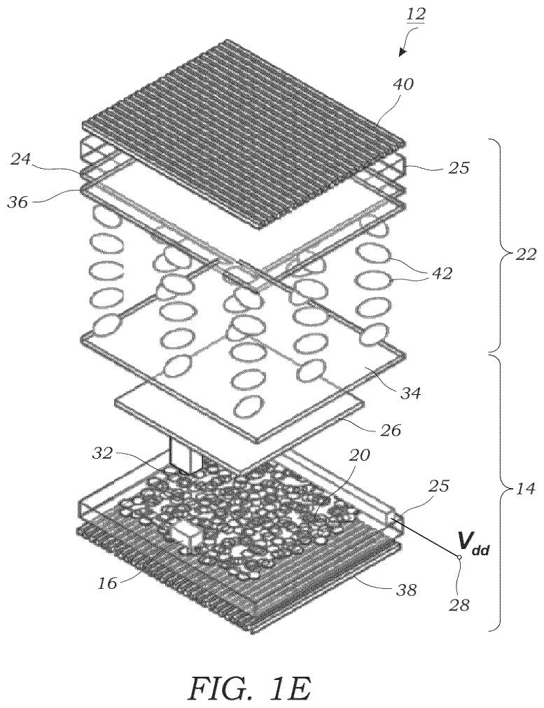

With reference to FIGS. 1A-1E, an optoelectronic neuron array 10 is illustrated for nonlinear optical modulation of incident light 100. The incident light 100 includes broadband spatially incoherent light. In one particular embodiment, the incident light 100 is ambient light. As explained herein, a proof-of-concept optoelectronic neuron array 10 was fabricated that includes 10,000 pixels 12 arranged in an array 10 of parallel connected optoelectronic neurons (see e.g., FIG. 1C). It should be appreciated that additional or fewer pixels 12 can be included in the array. Each pixel 12 of the optoelectronic neuron array 10 includes an independent two-dimensional (2D) transparent phototransistor (TPT) 14 which functions as the as the photo-gate, and a liquid crystal (LC) cell 22 that simultaneously operates as the load resistor and the optical modulator, forming an optoelectronic neuron or pixel 12 (FIGS. 1B-1E). The 2D TPT 14 may, in one embodiment, be formed as layer(s) formed by 2D van der Waals thin films (VDWTFs) as described herein. In particular, each pixel 12 of the optoelectronic neuron array 10 includes a 2D TPT 14 having a source electrode 16, a drain electrode 18, and a channel 20. The channel 20, in one embodiment, includes a molybdenum disulfide (MoS₂) channel 20. The LC cell 22 (also referred to as LC modulator) is disposed adjacent to the TPT 14 and includes an indium tin oxide (ITO) ground electrode 24 located at one end thereof (e.g., top in orientation seen in FIG. 1B). As best seen in FIGS. 1D and 1E, an intermediate ITO electrode 26 is interposed between the TPT 14 and the LC cell 22. The source electrode 16 of the TPT 14 is electrically connected to the intermediate ITO electrode 26 and the drain electrode 18 is electrically connected to a supply voltage (V_{dd}) applied by a voltage source 28. The applied voltage source 28 may include a direct current (DC) voltage source 28 as explained herein.

An optically transparent insulating layer 30 such as SU-8 is disposed between the channel 20 and the intermediate ITO electrode 26 (FIG. 1D) except for an electrically conductive via 32 disposed therein that electrically connects the source electrode 16 of the TPT 14 to the intermediate ITO electrode 26. The LC cell 22 includes a first alignment layer 34 and a second alignment layer 36 oriented generally orthogonal to the first alignment layer 34 so the LC molecules 42 contained in the LC cell 22 gradually twist in the LC cell 22. The first and second alignment layers 34, 36 may be formed from polyvinyl alcohol (PVA), in one embodiment. The optoelectronic neuron array 10 includes first polarizer 38 disposed on or adjacent to the TPT 14 on the input side of optoelectronic neuron array 10 and a second polarizer 40 disposed on or adjacent to the LC cell 22 at the output side. In some embodiments, the first polarizer 38 and the second polarizer 40 are oriented generally orthogonal with respect to each other. In other embodiments, the first polarizer 38 and the second polarizer 40 are oriented generally parallel with respect to each other. The transmission properties of the optoelectronic neuron array 10 are tuned by varying the supply voltage V_{dd} applied to the drain electrode 18.

The incident light passing through the 2D-TPT layer 14 modulates its resistance, which further regulates the voltage drop across the LC cell 22 to modulate the transmitted light through the neuron or pixel 12. In this design, the light beam modulates its own amplitude depending on the incident power at each individual neuron or pixel 12 of the optoelectronic neuron array 10. The desirable pixel 12 performance (nonlinear modulation) was achieved through a distinct working mechanism using local optoelectronic logic feedback to achieve intelligent modulation of the transmitted optical signal. The internal photoconductive gain allows a large change in the TPT conductance under low illumination (0.1-10 mW/cm²). The controllable and optimizable resistance match of the TPT 14 and LC cell 22 converts this conductance change to a large change in the voltage drop across the LC cell 22, which enables strong nonlinear behavior in the LC cells 22. This heterogeneously integrated architecture allows independent optimization of the TPTs 14 and LC cells 22 for desired performance metrics beyond the intrinsic tradeoff limits of a given material, such as in conventional photochromatic or photorefractive devices.

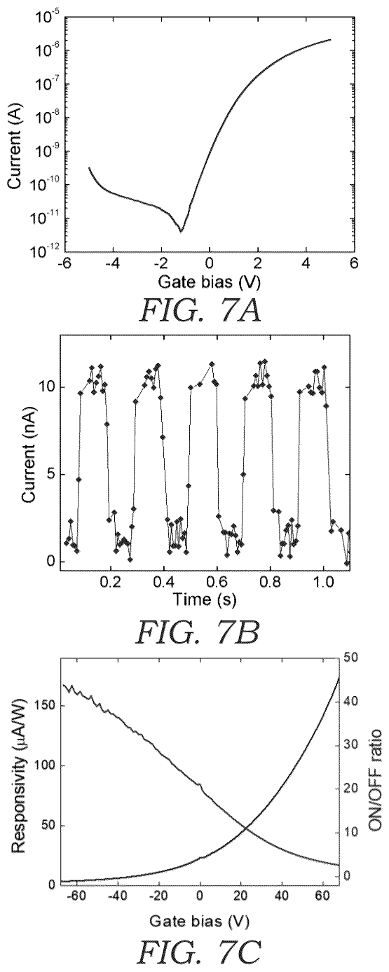

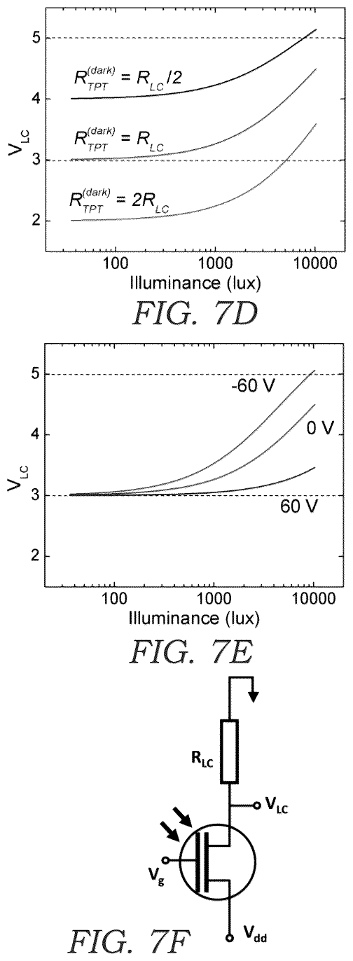

With reference to FIGS. 1B-1D, electrical current flows through the TPT 14 to the ITO intermediate electrode 26, then to the end ITO electrode 24, which is grounded. The LC cell 22 also works as an optically inactive resistor. Self-amplitude modulation of light is based on the optoelectrical operation of the combined TPT-LC stack. The TPT 14 is highly resistive at low input optical power, so most electrical fields (schematically illustrated by the arrow E, thick solid line representing strong field, thin dashed line representing weak field in FIG. 1D) fall on the TPT 14. The LC cell 22 is unperturbed and remains optically transmissive. This is seen in the left-most pixel 12. The equivalent circuit is shown adjacent to the pixel 12 (and see FIG. 7F). The TPT 14 is highly resistive in this configuration. Conversely, at high input optical power, the TPT 14 becomes conductive so most electrical field falls on the LC cell 22 as seen in the right-most pixel 12, shutting off or strongly attenuating the optical transmission (FIG. 1D).

FIG. 1B schematically illustrates an optoelectronic neuron array 10 that illustrates how each pixel 12 of the array 10 operates to independently process low-power broadband incoherent light that is input to the optoelectronic neuron array 10. Different optical intensities input to the pixels 12 are individually processed to adjust their respective optical transmissive properties. In this embodiment, pixels 12 illuminated with low power incoherent light largely passes through unattenuated while pixels illuminated with higher power incoherent light substantially attenuates the transmitted light therethrough.

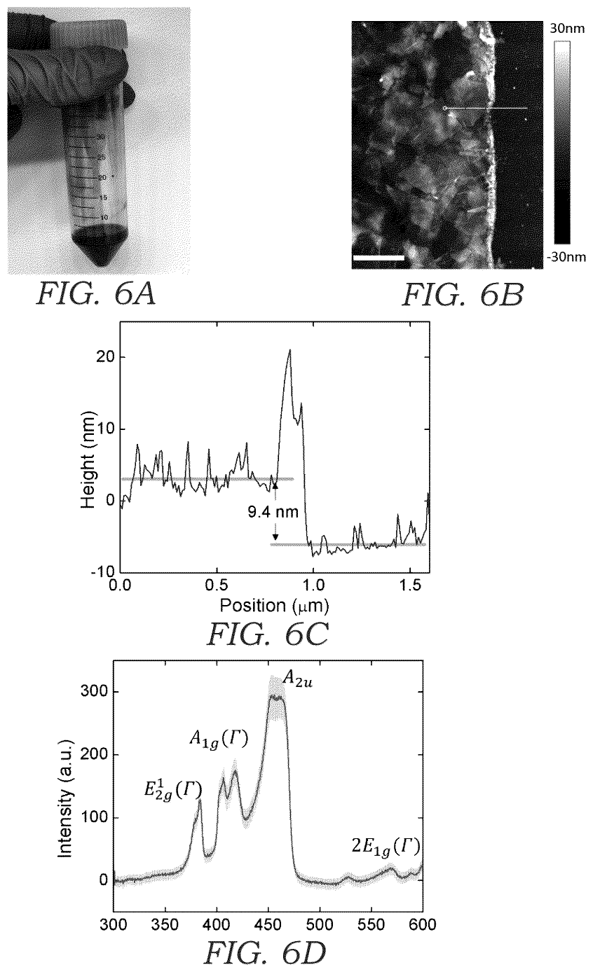

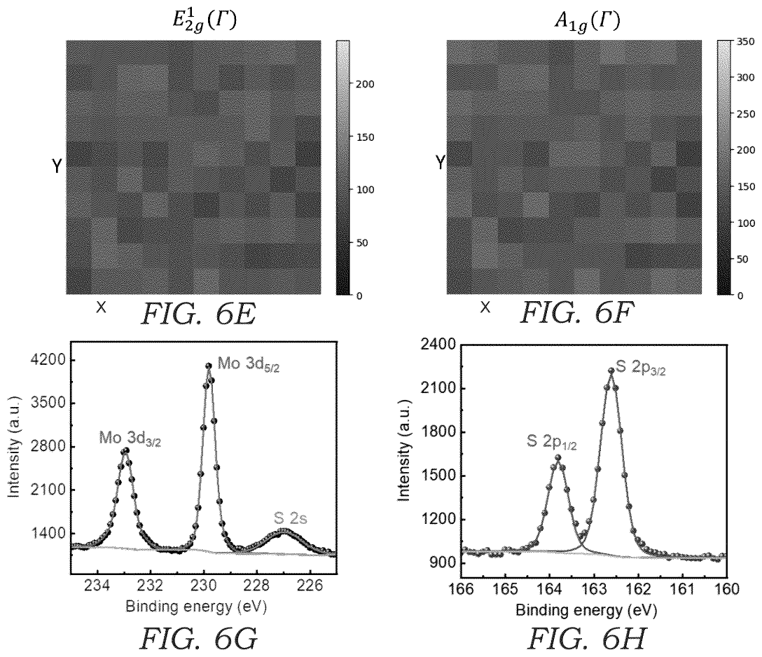

The TPTs 14 were fabricated using solution-processed 2D van der Waals thin films (VDWTFs), which are constituted by staggered 2D MoS₂ nanosheets (see Methods for details). With dangling-bond-free VDW interfaces among the staggered 2D nanosheets, the solution-processed VDWTF features excellent semiconductor properties (see FIGS. 6A-6H and FIGS. 7A-7E), which is essential for the required optical response and electrical operation frequency. The transparency of the VDWTFs can be tuned with controlled film thickness. The low-temperature solution process of ultrathin MoS₂ VDWTF allows depositing the semiconducting film on arbitrary substrates at wafer scale, offering an ideal material platform for making TPTs 14 and heterogeneous integration with various optical modulators with few processing constraints.

The MoS₂ VDWTF was first produced on a glass substrate 25 (FIGS. 1D and 1E), patterned the VDWTF into TPT channels 20, and then defined Cr/Au contacts. The TPT drain electrodes 18 are connected to the supply voltage (V_{dd}), and the source electrodes 16 are connected to an intermediate ITO electrode 26 stacked over the TPT pixel. An optically transparent insulating layer 30 (SU-8) isolates the intermediate ITO electrode 26 from the TPT channel 20 (except for the via 32) to remove the leakage current and parasitic capacitance. The ITO electrode 24 located at the top of the LC cell 22 modulates a twisted nematic LC cell 22, which works both as a voltage divider and an optical modulator (FIGS. 1B-1E). Finally, a pair of orthogonal polarizers 38, 40 sandwich the TPT-LC stack (see Methods for details on the material preparation and device fabrication).

The 10,000-pixel optoelectronic neurons or pixels 12 were connected in parallel, with the TPT terminals connected to V_{dd} and the LC terminals connected to the common ground (GND) (FIGS. 1A and 1D). Despite this simplified circuit layout, each TPT 14 has an independent optical gate (only controlled by the local illumination intensity on each pixel) that modulates the resistance of the individual TPT 14 without significant electronic crosstalk from neighboring pixels 12 (FIG. 1B). The change of the TPT resistance further modulates the voltage drop across the LC cell 22 in the specific pixel 12 and thus modulates the optical transmission of this pixel 12. The LC cell 22 has a resistance of R_{LC}~10 GΩ per pixel (see Supplementary Note 1). The TPT channel 20 was engineered to make its dark resistance higher than R_{LC}, and its light resistance below R_{LC}. Consequently, most of V_{dd} falls on the TPT 14 when it is dark, leaving the LC cell 22 transparent under rotating polarization (FIG. 1D, left most pixel 12). When the light is intense enough, most of V_{dd} drops on the LC cell 22. The strong electric field rotates the LC molecules to suppress the optical transmission (FIG. 1D right most pixel 12), resulting in a nonlinear transmission function. In this way, even though all TPTs 14 and LC cells 22 are connected together, there is negligible crosstalk between individual pixels 12 in terms of optical modulation. Each individual optoelectronic neuron/pixel 12 in the 10,000-pixel array 10 responds independently to local light intensity, but works in parallel concurrently without the need of electronic pixel scanning, which is essential for ensuring fast, low-power, and scalable operation.

### 2D Transparent Phototransistor Array

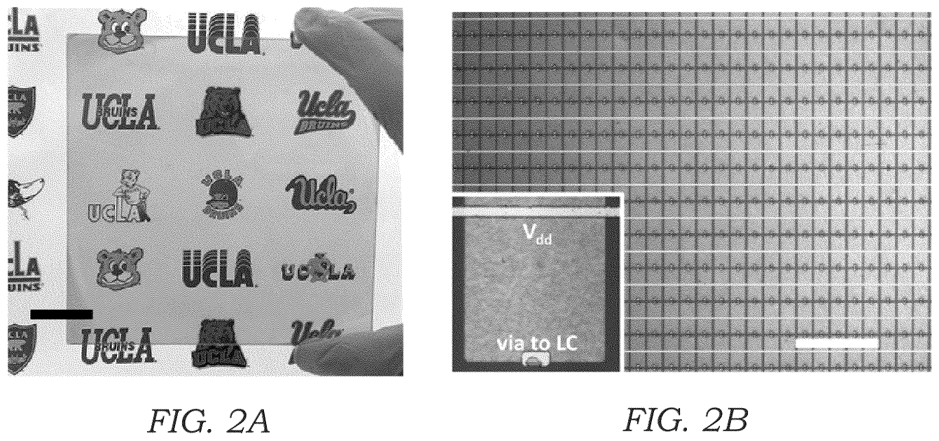

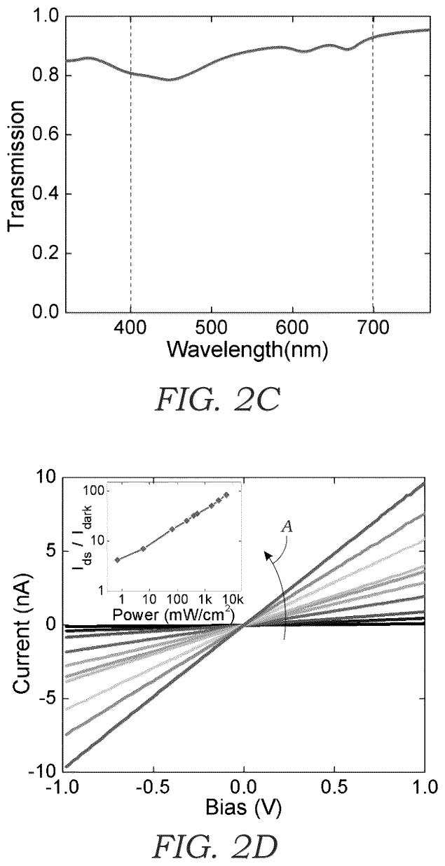

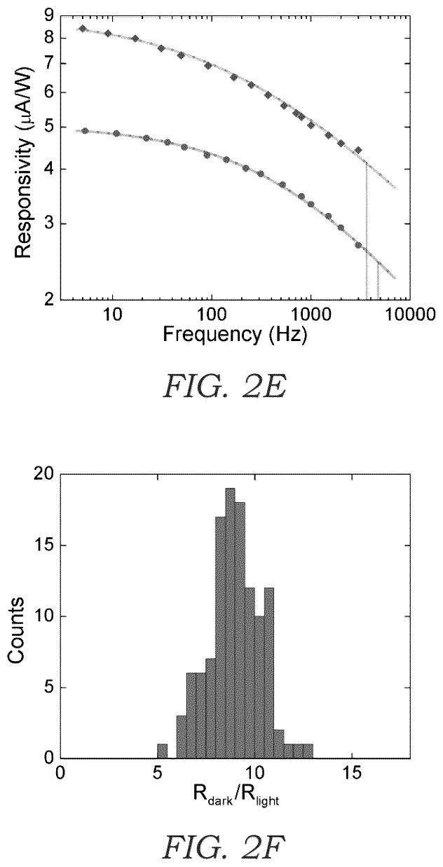

The VDWTF was first prepared on a 10 cm×10 cm glass substrate to demonstrate its uniformity and transparency over a large area (FIG. 2A). FIG. 2B shows the TPT array under an optical microscope, which was fabricated using standard photolithography processes. The length and width of the TPT 14 are 90 μm×85 μm, with an array periodicity of 100 μm. The TPT layer exhibits a transmission of 88.5% at 550 nm and generally contributes to less than 20% decrease in transmission within the visible band (FIG. 2C). FIG. 2D shows the photo response of a VDWTF TPT wired out for single-device tests, where a 633-nm laser was used as the light source. The beam was defocused with a spot diameter overlapping with the 100 μm×100 μm pixel area (see Methods). The device design needs a large ON/OFF current ratio under illumination/darkness for the corresponding optoelectronic neuron to achieve large nonlinearity. The channel current increases from 0.12 nA in the dark state to 1.96 nA at an input illumination intensity of 65.8 mW/cm², corresponding to an ON/OFF ratio of 16. This large resistance change under a moderate illumination intensity is essential for creating sufficient voltage modulation across the LC cell 22 to produce a strong nonlinear transmission contrast (FIG. 7C).

Next, a chopper was used to modulate the light and study the photo response speed of the device at 488 nm and 633 nm wavelengths. These experiments show that the 3 dB cutoff frequencies are above 3 kHz for both wavelengths (FIG. 2E). Moreover, the responsivity at the red light is only slightly lower than that at the blue light because the bandgap of the few-layer MoS₂ is below 1.9 eV (>653 nm). The photo response was further characterized under the illumination of a thermal lamp (at an intensity of ~21 mW/cm², see Methods), revealing a dark/light resistance ratio of 9.0±1.3 (mean and standard deviation) (FIG. 2F), suggesting a relatively uniform photoresponse under broadband spatially incoherent light.

### Nonlinear Self-Amplitude Modulation

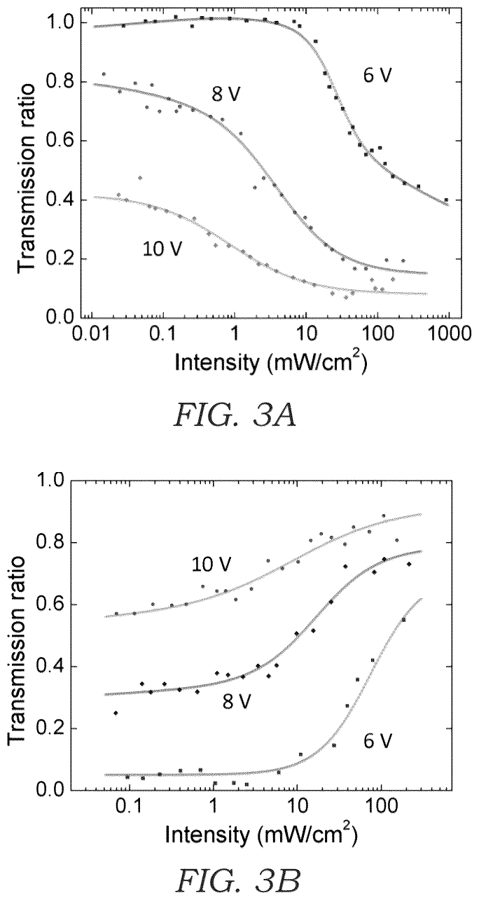

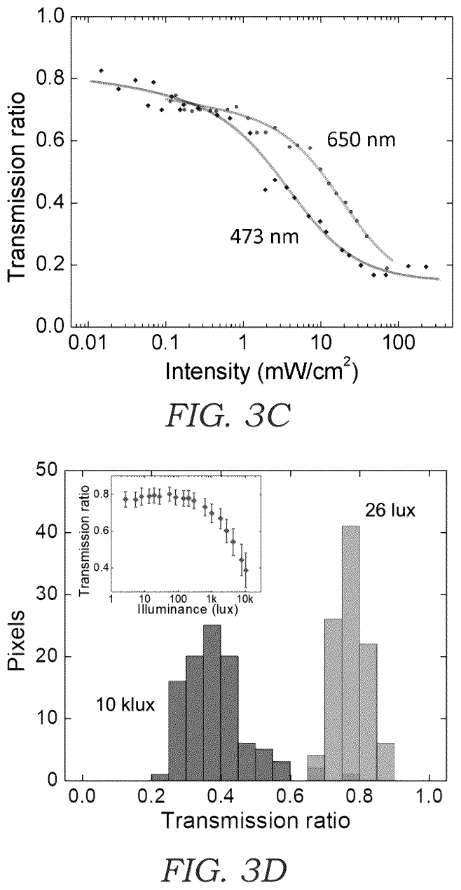

The nonlinear amplitude modulation of the optoelectronic neurons/pixels 12 were evaluated by quantitatively analyzing the transmission of a 473-nm laser under varying incident intensity. The transmission ratios are normalized with respect to the high-transmission state (i.e., at V_{dd}=0 V for FIG. 3A). The results showed that the transmission drops substantially with increasing illumination power, showing a modulation onset intensity of 0.1-10 mW/cm² (FIG. 3A). The exact onset power and modulation ratio can be readily tuned by varying the supply voltage (V_{dd}). An opposite nonlinear mode can also be achieved with the same device by rotating the two polarizers to be parallel to each other: in this case, the transmission ratio is low for dim light, but increases to near unity at high illumination power (see FIG. 3B). The nonlinearity was further tested under 650 nm laser (FIG. 3C and white LED (FIG. 3D) illumination and observed similar nonlinear responses. The nonlinear onset for white LED illumination of ~1,000 lux, equivalent to ~0.5 mW/cm², which is more than two orders of magnitude smaller than typical sunlight intensity (FIG. 3D, inset), demonstrating that the device is fully functional under low-intensity broadband spatially incoherent light. No transmission modulation was observed on the LC devices without the TPTs under the same test conditions, excluding a possible thermal contribution to the observed nonlinearity.

To evaluate the overall yield and uniformity of the optoelectronic neuron array 10, the transmission at V_{dd}=6 V and 14 V under uniform, white-LED illumination was examined. The uniform ON/OFF transmittance suggests an essentially unity yield for 10,000 devices fully covered in the field of view. The uniformity of the nonlinear response of 99 devices under different illumination levels were further characterized with a histogram (FIG. 3D), demonstrating distinct transmission under different illumination fluxes for all devices.

Integration of the Optoelectronic Neuron Array with a Cellphone Camera for Glare Reduction

Next, the optoelectronic neuron array 10 was integrated with an image capture device 50 in the form of a cellphone camera having an image sensor for intelligent glare reduction. Bright glares, such as sun glare and high beams during driving, stray laser beams in labs, or welding glares in factories, can trigger corneal reflexes or damage the human eye, as well as saturate image detectors in cameras, obscuring valuable information. Thus, bright glares are undesirable in various human/robot working conditions. Uniform attenuators or polarizers are used in sunglasses to solve this issue partially. However, such attenuators are linear optical elements and uniformly attenuate the glare and the working environment by the same level, and thus cannot selectively maintain useful information. Ideally, a glare-reduction imaging solution should selectively dim the bright rays while efficiently capturing the useful information from the surrounding, less-bright objects, which is highly desirable for many applications.

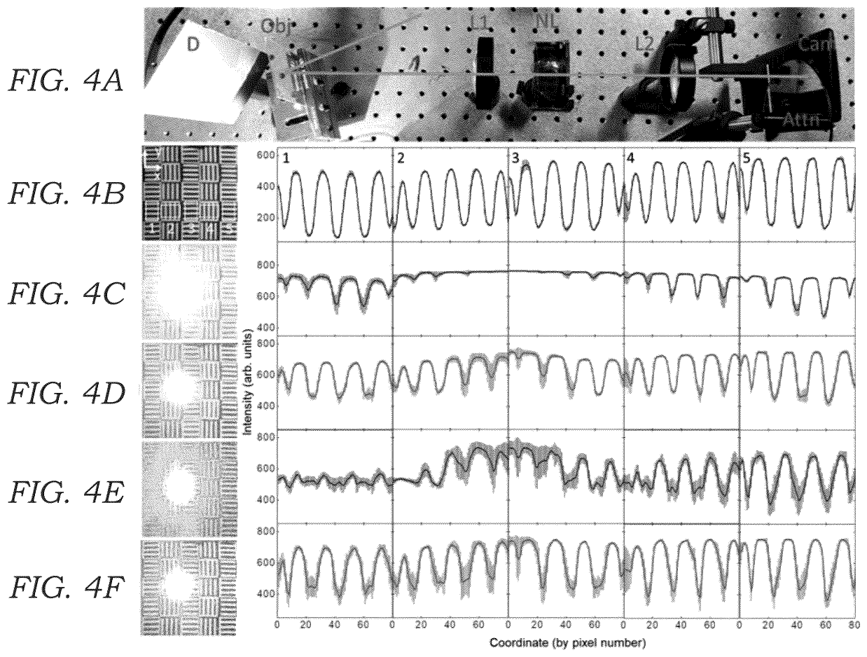

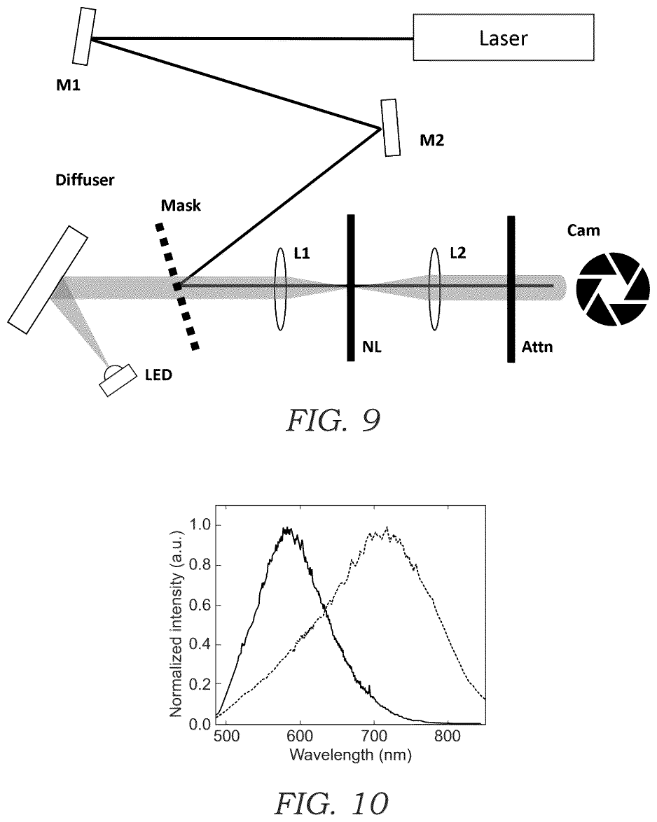

The nonlinear optoelectronic neuron array 10 offers an ideal solution to this challenge as it can filter out glares at a desired intensity threshold (that can be fine-tuned electronically using V_{dd}), operating at a broad visible spectrum faster than the typical video frame rate. Therefore, it can intelligently suppress fast-changing glares over a large field of view with an electrically tunable intensity threshold. To showcase this capability, an imaging system was constructed using a cellphone camera as the image capture device 50 integrated with the optoelectronic neuron array 10 (see FIG. 4A and FIG. 9). With this setup, grating-like object patterns were imaged under white light illumination with or without an intentionally generated intense glare (473 nm laser) to demonstrate intelligent glare reduction.

The patterns were clearly resolved when there were no glares (FIG. 4B). After turning on the glare while keeping the exposure and focus condition of the cellphone camera 50 the same (FIG. 4C), the image was saturated by the intense scattered glare in the center, leaving little detectable features in the surrounding areas. Next, V_{dd}=6 V was applied to switch ON the optoelectronic neurons. This voltage was chosen to place the LC cells 22 right below the nonlinear transmission threshold for ambient light, and well above the threshold when intense glares turn on the TPTs 14. The intense glare beam pushed the illuminated optoelectronic neurons or pixels 12 to the low-transmission state. As a result, the captured cellphone image shows a much dimmer glare, while faithfully resolving the grating patterns and recovering the spatial information (FIG. 4D) that was lost at V_{dd}=0 V (FIG. 4C). Direct transmission power measurement with a power meter shows the glare power drops by 84% when compared to its value at 0 V, while the non-glare region showed negligible transmission reduction.

Since most current camera systems often adopt auto-exposure software to adjust the exposure under different lighting conditions, the impact of the nonlinear filtering was further compared under auto-exposure settings. Turning on the auto-exposure of the cellphone camera 50 without nonlinear filtering (V_{dd}=0 V) leads to a significant loss of the surrounding object patterns (FIG. 4E), which is due to the software-adjusted reduction of the image exposure resulting from the intense glare beams. Turning on the nonlinear filtering (V_{dd}=6 V) under the auto-exposure mode restores the patterns of the input scene as desired (FIG. 4F). These studies clearly highlight that the optoelectronic neuron array 10 acts as a nonlinear filter that can effectively reduce the negative impact of intense glares in a way that is not readily possible with software-corrected auto-exposure processes.

The glare degrades the image quality of its surrounding area in two ways: for regions close to the glare center (Box 2, 3 in FIG. 4C), the intense glare saturates the image; for regions slightly further away (Box 1, 4, 5), the irregular glare overlaps with the object patterns and significantly contributes to noise. The SNR and contrast of the acquired cellphone images were quantified to better highlight these observations (see the boxes in FIG. 4B). The average and standard deviation values were computed along the grating lines (x-axis for Box 1 in FIG. 4B) to get the cross-sectional profiles perpendicular to the grating lines (FIG. 4B-4F right five panels). The noise increases by over ten times in the dark regions (see the error bars for Box 1 in FIGS. 4B, 4C) after turning on the glare. As expected, the contrast between the black and white stripes of the input object is substantially suppressed under the glare, leaving few resolvable features. Evaluated at Box 1 in FIG. 4B, the SNR (see Methods) is 14.2 for the no-glare case, which drops to 1.08 with the bright glare when the nonlinear filtering is off, and is restored to ~5.50 when the nonlinear filtering is turned on. Under the auto-exposure setting, the image SNR collected by the cellphone camera 50 decreases to 0.86 due to the glare (without the nonlinear filtering), which increases to ~3.51 when the nonlinear filtering is on, thanks to the intelligent suppression of the glare by the optoelectronic neuron array 10. The SNR and contrast over all five selected boxes show considerably enhanced SNR and pattern contrast over different regions when the optoelectronic neuron array 10 was switched on.

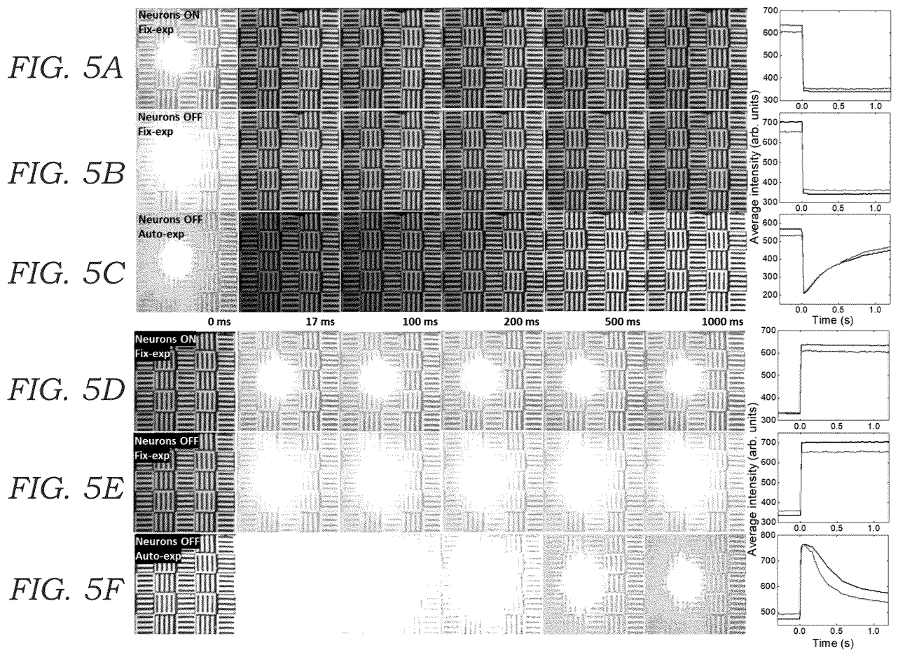

The response speed of the optoelectronic neuron array 10 in reducing dynamic glares was evaluated by taking videos with the laser-induced glare frequently switched on and off, and observed a similar glare reduction performance under dynamic glare conditions. If the optoelectronic neurons/pixels 12 were to have a response speed slower than the video frame rate (60 Hz), one would expect a delayed transmission change, leading to a dark spot at the glare center right after the glare is shut off or an overexposure when the glare is just turned on. Importantly, no such phenomenon was observed even in the first frame after the laser was turned off (FIG. 5A) or on (FIG. 5D). The glare reduction response speed was further estimated by calculating the average intensity of the displayed area and the selected rectangle region (in FIG. 5A). The intensity temporal evolution showed an instant switch within the first frame after the glare was off (FIG. 5A, right panel), suggesting a faster response than the video frame rate of 60 Hz (~17 ms). Comparing the dynamic video frame evolution when the optoelectronic neurons are on (FIG. 5A) with that when they are off (FIG. 5B), it is apparent that the video obtained with the optoelectronic neurons/pixels 12 on shows a clear benefit when there is glare, and preserves the same image quality starting with the first frame after the glare is turned off, further confirming the instant response of the optoelectronic neuron array 10. In contrast, with the software-controlled auto-exposure, the cellphone camera 50 showed a series of darker frames initially when the glare is suddenly turned off, and did not reach a normal exposure condition until beyond ~0.1 s (FIG. 5C), due to the delayed response from the software-adjusted exposure reduction when the glare was on.

Similarly, when the laser glare was turned on, the optoelectronic neuron array 10 showed an instant response to achieve a significantly improved video quality (FIG. 5D) over that obtained with neurons off (FIG. 5E); in contrast, the software-adjusted image exposure takes more than 1 second to stabilize (FIG. 5F). The software-controlled auto-exposure correction is much slower because it needs multiple frames to adjust the image exposure, which can take seconds depending on the algorithm, computing hardware and illumination conditions. These analyses and the data in FIGS. 5A-5F demonstrate that the optoelectronic neuron array 10 can rapidly respond to dynamically varying illumination conditions.

Integration of Optoelectronic Neuron Array with Optical Neural Network

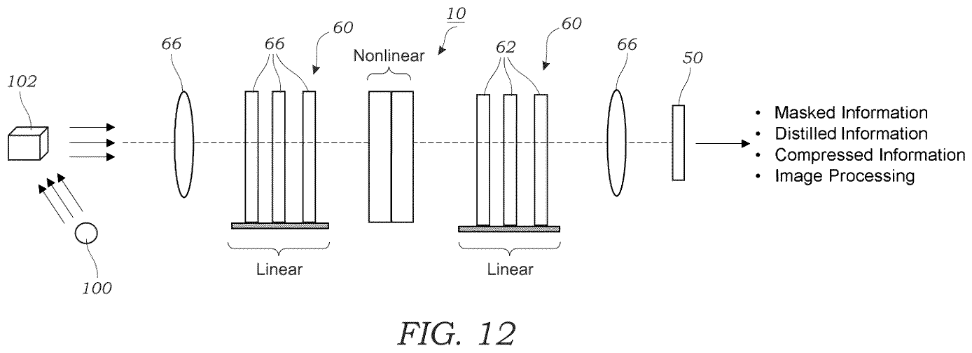

In some embodiments, the optoelectronic neuron array 10 may be combined with one or more optical or diffractive neural networks 60 as illustrated, for example, in FIG. 12. Optical or diffractive neural networks 60 such as those disclosed in U.S. Pat. No. 11,392,830, which is incorporated by reference herein, utilize physical substrates or layers 62 that diffract light (either through reflection or transmission) in specific ways to alter in input optical image or signal. A computer-based model of the optical or diffractive neural network 60 is first generated in order to train the physical “neurons” in the physical network that is to perform the desired task. The desired task may be, for example, to identify a particular object or shape within an input image of course other tasks are contemplated. Once the training of the numerical model is complete, one obtains a blue-print of the necessary physical specifications of the actual physical embodiment of the optical or diffractive neural network 60 that is to be employed in real life. The optical transmissive and/or reflective substrate layers 62 that form the optical or diffractive neural network 60 can then be manufactured and placed in an optical path of the input optical image or signal to perform the desired transformation at the output of the optical or diffractive neural network 60. The optoelectronic neuron array 10 may be placed along the same optical path of the optical or diffractive neural network 60. In some embodiments, the optoelectronic neuron array 10 may be located at the output (back) side of the optical or diffractive neural network 60 (or multiple such optical or diffractive neural networks 60) which is located before an image capture device 50. The image capture device 50 may include a camera, microscope, or other imaging device (e.g., imaging device that uses an image sensor or optical detector(s)). In other embodiments, the optoelectronic neuron array 10 may be located at the input (front) side of the optical or diffractive neural network 60. For example, in one embodiment, the optoelectronic neuron array 10 may be interposed along an optical path between two optical or diffractive neural networks 60 as illustrated in FIG. 12. An image capture device 50 such as an image sensor or optical detector(s) is placed after the last optical or diffractive neural network 60 to function as an optical processor. The optical or diffractive neural networks 60 operate, in one embodiment, as linear diffractive layers giving the optical processor a linear-nonlinear-linear structure.

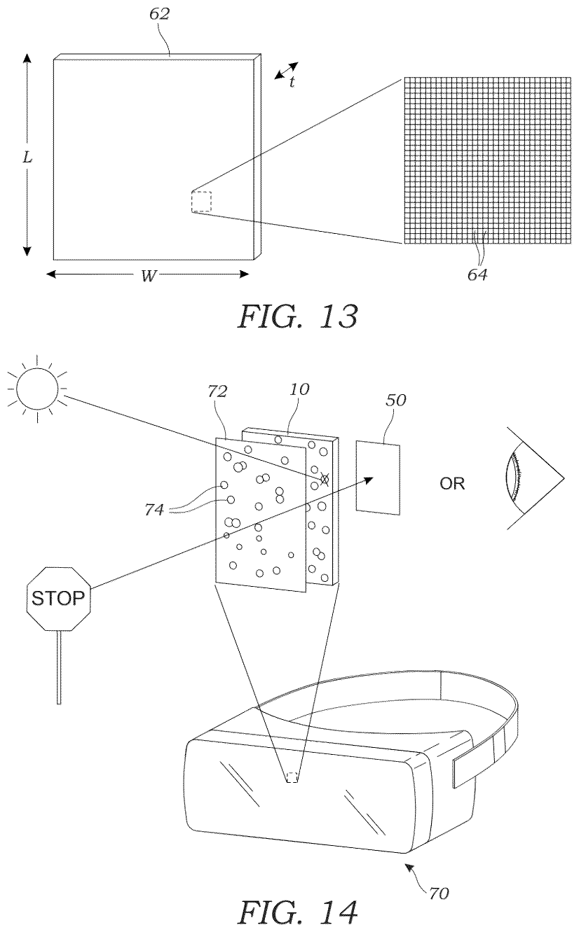

With reference to FIGS. 12 and 13, each of the optically transmissive and/or reflective substrate layer(s) 62 have a plurality of physical features 64 formed on or within the one or more optically transmissive or reflective substrate layer(s) 62 and having different transmission and/or reflection properties as a function of the lateral coordinates across each substrate layer 62. In one embodiment, the substrate layers 62 are transmissive to light whereby light diffracts as it passes through the various layer(s) 62 and interacts with physical features 64 located in the layer(s) 62. In other embodiments, the layer(s) 62 may include reflective layer(s) 62 where light reflects of the surface(s) thereof. Each layer 62 of the optical or diffractive optical network 60 has a plurality of physical features 643 (FIG. 13) formed on the surface of the layer 62 or within the layer 62 itself that collectively define a pattern of physical locations along the length and width of each layer 62 that have varied transmission parameters/coefficients (or varied reflection parameters/coefficients for a reflection embodiment).

In one embodiment, the various neurons are formed by physical features 64 of differing the thickness of layer(s) 22. In one embodiment, the different thicknesses (t) of the physical features 64 modulate the phase of the light passing through the layer 62. This type of physical feature 64 may be used, for instance, in the transmission mode embodiment. The different thicknesses of material in the layer 62 forms a plurality of discrete “peaks” and “valleys” that control the transmission parameters/coefficients of the neurons formed in the layer 62. The different thicknesses of the layer 62 may be formed using additive manufacturing techniques (e.g., 3D printing) or lithographic methods utilized in semiconductor processing. This includes well-known wet and dry etching processes that can form very small lithographic features on a substrate. Lithographic methods may be used to form very small and dense physical features on the layer 62 which may be used with shorter wavelengths of the light.

Alternatively, the transmission function of a neuron can also be engineered by using metamaterial or plasmonic structures as the physical features 64. Combinations of all these techniques may also be used. In other embodiments, non-passive components may be incorporated in into the layer(s) 62 such as spatial light modulators (SLMs). SLMs are devices that imposes spatial varying modulation of the phase, amplitude, or polarization of a light. One or more of these SLMs may be incorporated in the layer(s) 62. SLMs may include optically addressed SLMs and electrically addressed SLM. Electric SLMs include liquid crystal-based technologies that are switched by using thin-film transistors (for transmission applications) or silicon backplanes (for reflective applications). Another example of an electric SLM includes magneto-optic devices that use pixelated crystals of aluminum garnet switched by an array of magnetic coils using the magneto-optical effect. Additional electronic SLMs include devices that use nanofabricated deformable or moveable mirrors that are electrostatically controlled to selectively deflect light. Thus, in some embodiments, the physical properties of the layers 62 may be adjusted or tuned as a function of time.

The physical features 64 formed on or in the layer(s) 62 thus create a pattern of physical locations within the layer(s) 62 that have different transmission properties as a function of local coordinates (e.g., length and width and in some embodiments depth) across each layer 62. In some embodiments, each separate physical feature 64 may define a discrete physical location on the layer 62 while in other embodiments, multiple physical features 64 may combine or collectively define a physical region with a particular transmission/reflection parameter or coefficient. These physical features 64 or collections of such physical features 64 form the optical “neurons” of the optical or diffractive optical network 60 that are analogous to the neurons in electronic neural networks.

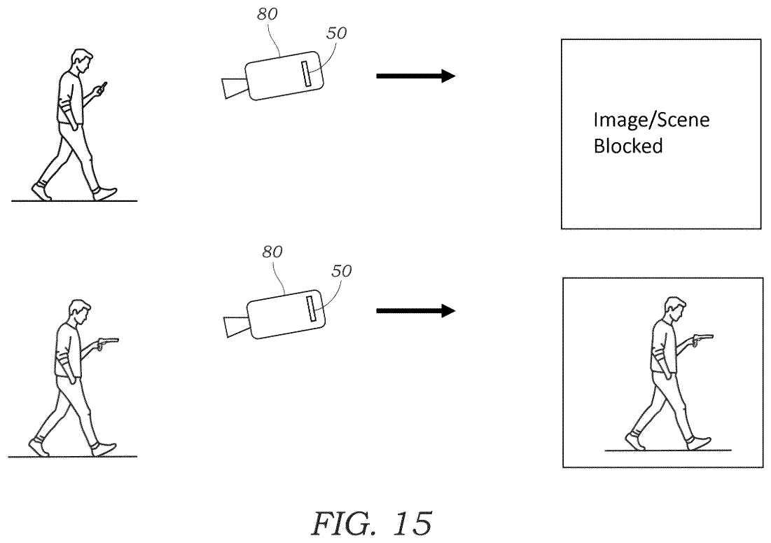

As seen in FIG. 12, one or more lenses 66 may be placed along the optical path of the system or device that uses the optoelectronic neuron array 10 and the optical or diffractive optical network(s) 60. The one or more lenses 66 are optional, however, and some embodiments may not need any or all lenses 66. As seen in FIG. 12, a source of light 100 illuminates an object 102 and reflected light passes along an optical path (dashed line) through a first lens 66 and through a first optical or diffractive optical network 60. This first optical or diffractive optical network 60 may process the light in a linear manner as is illustrated. The light passing through the first optical or diffractive optical network 60 then encounters the optoelectronic neuron array 10 where it undergoes non-linear transmission. The light then continues into a second optical or diffractive optical network 60 and then another lens 66 that directs the light onto an image capture device 50 such an image sensor or optical detector(s). The system or device illustrated in FIG. 12 may be used to perform masking of a scene or imaging as discussed herein (e.g., FIG. 15). This may include so-called ethical surveillance where privacy concerns remove scenes or images from being recorded except for those deemed to be a threat or security issue. The system or device may also be used to distill information such as product defect inspection, medical diagnosis, and the like. The system or device may also be used to process compressed high dimensional information such as hyperspectral or 3D information. The system or device may also be used for image processing such as glare reduction, pattern or image recognition, and the like.

In one embodiment, the one or more optically transmissive and/or reflective substrate layer(s) 62 arrays collectively process and/or extract (i.e., allow transmission) and/or reject (i.e., not allow transmission) object and/or scene information from an input image input to the optically transmissive and/or reflective substrate layer(s) 62. For example, in the context of the embodiment of FIG. 15, a normal scene or image is fully blocked or rejected. However, when objects of interest (e.g., a gun in this particular example) are detected, the image or a portion thereof (e.g., just the gun as one example) is transmitted and captured by the image capture device 50 (e.g., security camera). This can then trigger, for example, an alarm or other warning.

Here, the optoelectronic neuron array 10 is used in conjunction with an optical or diffractive neural network 60 which can be used for various applications including, for example, extreme glare reduction, artificial intelligence (AI)-based cameras and high-throughput AI accelerators. The optoelectronic neuron array 10 can achieve a high frame rate with tailored nonlinearity, and implement the activation layer for optical neural networks and novel applications discussed below. By directly integrating the transparent photodetector 14 on top of the LC cell 22 for each pixel 12 of the optoelectronic neuron array, the incident light will first trigger the TPTs 14, and the photo response from each detector pixel 12 will drive the LC cell 22 behind it, and thus will modulate the phase and/or the amplitude of the transmitted beam. Together, the directly integrated TPTs 14 and LC cells 22 work as a highly effective optical activation layer. In this way, by independently tuning the TPT 14 layer and the LC cell 22 layer, it is possible to tailor the nonlinearity of the activation layer for the diffractive or optical neural networks 60 such as that illustrated in FIG. 12. The design also allows the networks 60 to work under natural illumination, forming the basis of intelligent camera systems. The transparent diffractive neural network 60 will process the optical signal before it reaches the image sensor or other image capture device 50, and can open up diverse exciting new opportunities.

### Extreme Glare Reduction

Bright glare triggers the corneal reflex in human eyes. It impedes human vision for driving and other tasks such as welding. Normal sunglasses dim the glare and the scene uniformly. Integrating the optoelectronic neuron array into an intelligent sunglasses/goggles and machine vision designs can significantly suppress the glare and preserve the scene brightness as seen in FIG. 14. In this embodiment, goggles or glasses 70 are shown that integrate a mask 72 that is disposed on the front-end of an optoelectronic neuron array 10. The mask 72 includes a plurality of apertures 74 formed therein. The apertures 74 may be randomly populated over the mask. The optoelectronic neuron array 10 is positioned along the optical path behind the mask 72. The mask 72 may be separated from the optoelectronic neuron array 10 by a small gap, e.g., several millimeters in some embodiments. As illustrated FIG. 14, light from an object (e.g., stop sign in this illustrated embodiment) as well as bright sunlight from the sun is directed onto the goggles or glasses 70. The mask 72 projects the sunlight's shades onto the optoelectronic neuron array 10, which turns dark under intense power from the sunlight rays and prevents transmission through the optoelectronic neuron array 10 as illustrated in FIG. 14. The setup self-aligns the glare to the fully-blocked regions of the optoelectronic neuron array 10, but partially transmits rays from other angles. For example, light from the stop sign passes through the mask 72 and through the optoelectronic neuron array 10 which is projected onto an eye or image capture device 50 such as an image sensor. The mask 72 patterns of the apertures 74 can be sub-millimeter in diameter and close to eyes, so that they do not degrade the image quality. Ray-tracing simulations show >100 times darker glare than through a simple attenuator with similar scene brightness, and may greatly expand the visual capability of naked eye as well as machine vision and computational imaging systems. While this embodiment has been described in the context of goggles or glasses 70 the same anti-glare features may be embodied in other image capture devices 50 such as camera.

### AI Camera for Privacy-Protective Surveillance

Surveillance cameras can reduce crimes and save lives. However, possible abuses of the recorded videos may implicate privacy concerns, making some deployments ethically or politically unacceptable. The optoelectronic neuron array 10 may be used with an optical neural network 60 design that can be used to realize AI cameras 80 (FIG. 15) that mask and distill information before the light reaches the image capture device 50 of the AI camera 80 (e.g., image sensor such as a CCD or CMOS image sensor). In FIG. 15, a linear optical or diffractive neural network 60 along with the optoelectronic neuron array 10 is positioned along an optical path of an imaging device such within as an AI camera 80. The configuration may be same or similar that the arrangement illustrated in FIG. 12. Here, the AI camera 80 is used to mask information obtained from an image or video. For example, security cameras may utilize an optoelectronic neuron array 10 in combination with an optical or diffractive optical neural network 60 in which only scenes or images where weapons are present are recorded by the image capture device 50. In contrast, other visual or scene information that would otherwise be captured by the AI security camera 80 is physically masked and un-hackable. For example, with reference FIG. 15, the upper image illustrates a person walking and looking at their phone. Here, there is no weapon present so the entire image or scene is blocked. Moreover, the blocking occurs prior to any image being projected onto the image capture device 50 such as an image sensor of the AI camera 80. The image sensor does not even see the optical image or signal, thus making the AI camera 80 un-hackable. The AI camera 80 may also be used to distill information from an image (e.g., product defect inspection, medical diagnosis, etc.). The AI camera 80 may be used for pattern recognition or include glare reduction features as discussed herein. The AI camera 80 may also process high dimensional information such as hyperspectral or three-dimensional image information.

The optoelectronic neuron array 10 can support natural illumination in practical, real-world scenarios, which will be transformative for various security and defense related applications, among others. The proposed functionalities allow high-throughput detection and metrology applications, useful in e.g., agriculture, biomedical, and manufacturing industries, among many others. Lastly, the diffractive optical neural networks 60 working in combination with optoelectronic neuron arrays 10 (FIG. 12) present massive parallel inputs compared with integrated photonic-based AI accelerators and might therefore be orders of magnitude faster than electronic GPUs and TPUs in executing certain computational tasks.

A unique strategy was developed to create an optoelectronic neuron array 10 for broadband nonlinear modulation of spatially incoherent light. Beyond the nonlinearity and response speed, additional parameters should be considered for practical applications: the threshold optical intensity for the nonlinear response, and the total power consumption (optical absorption plus the electrical power consumption). The optoelectronic neuron array 10 tested herein has a nonlinear intensity threshold of ~1 mW/cm² for broadband visible spectrum (FIG. 3D). It absorbs ~20% of the incident photons in the TPT layer 14, corresponding to a photon power loss of 20 nW/neuron. The electrical power consumption is 1.8 nW/neuron with the typical nonlinear operation voltage at 6 V and a current density of 3 μA/cm². Thus, the total power consumed by the experimental optoelectronic neuron array 10 device is ~22 nW/neuron. Dynamic changes in the input light field could also lead to frequent charging/discharging of the LCs, but do not significantly contribute to the total power consumption (see Supplementary Note 1).

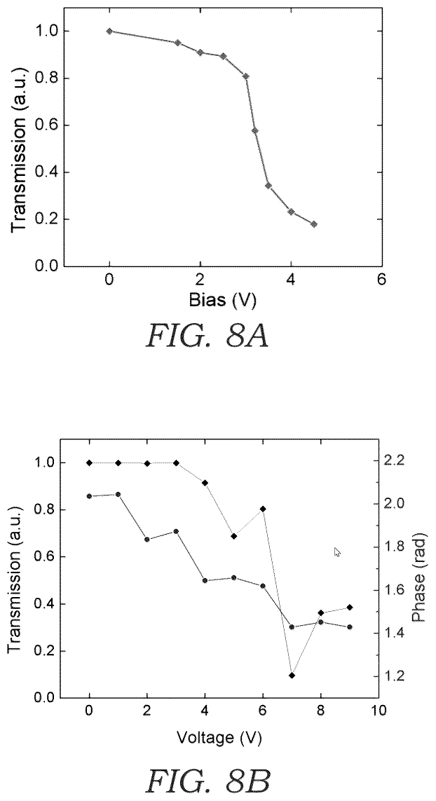

The performance of the proof-of-concept optoelectronic neuron array 10 is largely limited by suboptimal material processing and device fabrication protocols (particularly related to LC cells 22), and could be further improved by developing and adopting mature industrial processes. Thanks to the heterogeneous integration of 2D TPT 14 and LC cells 22, the TPT and LC layers can be optimized separately without tradeoffs. For example, the LC cells 22 used herein show a gradual modulation slope, requiring a ΔV ~2 V to switch from the high-transmission state to the low-transmission state (FIG. 8A). In contrast, the state-of-the-art LC modulators can achieve much steeper slopes, with a much smaller switching voltage ΔV<0.3 V. This means a smaller resistance change in TPTs 14 can trigger the LC cells 22. Another possible optimization is the lowest transmission value of LC, which relies on high-quality LC alignment layers 34, 36 and polarizers 38, 40. Commercial LC-based displays can achieve a contrast ratio beyond 5000, compared to ~10 in the proof-of-concept LC cells 22. This would correspond to a 500-fold stronger glare reduction when the industry-quality LC modulators are integrated with the optoelectronic neuron arrays 10. To shed more light on this opportunity, the device performance was modeled with optimized LC parameters and a better match between the TPT ON/OFF resistances and the LC resistance (see the discussion in Supplementary Note 1). This modeling indicates that the ultimate optical intensity threshold for ON/OFF switching can go below 56 μW/cm² for 633-nm illumination wavelength. The total power consumption per neuron scales linearly with the pixel area, and thus can be reduced substantially to 6.9 pW/neuron (27.7 μW/cm²) by scaling the pixel size down to 5 μm, as proved feasible in commercial LCD technologies. The LC cell 22 that was used herein was (4-cyano-4′-pentylbiphenyl, common name: 5CB) supports a modulation speed above 100 Hz. Taking this modest estimation of 100 Hz as the device speed, the total power consumption can be calculated as 69 fJ per nonlinear activation. FIG. 11B illustrates an estimation of the power consumption per unit area at different φ values. Even lower power consumption is possible with further material and device-level optimizations of LC cells 22 to increase the speed and scale down the device footprint.

It should also be noted that there is some non-uniformity with the current optoelectronic neuron array 10. A calibration may be conducted for more precise use of these nonlinear neurons for optical computing and computational imaging. In this case, the nonlinear optical threshold variations among the neurons/pixels 12 of a given optoelectronic array 10 could be measured and calibrated so that computer simulations or in-situ training can be optimized to best exploit the optical nonlinearity of each neuron/pixel 12 regardless of the device-to-device variations.

In summary, the invention heterogeneously integrated 2D TPTs 14 with LC cells 22 to form a 10,000-pixel nonlinear optoelectronic neuron array 10. The design enables nonlinear self-amplitude modulation of spatially-incoherent light, featuring a low optical intensity threshold, strong nonlinear contrast, broad spectral response, faster speed than video frame rate, and low photon loss. This optoelectronic neuron array 10 was further integrated into a cellphone-based imaging system and intelligent glare reduction was demonstrated by selectively attenuating bright glares while preserving the surrounding object information that is otherwise unrecognizable by the camera 50. This device 10 might find various applications in autonomous driving, photography, and security cameras. The nonlinear optoelectronic neuron array 10 could find broad uses in computational imaging and sensing fields, and opens the door for new nonlinear processor designs for optical computing using ambient light that is spatially and temporally incoherent.

### Methods

MoS₂ ink preparation. The raw molybdenite flake was electro-chemically intercalated by tetraheptylammonium bromide (THAB). 200 mg THAB was dissolved into 40 ml acetonitrile. The molybdenite was fixed on a copper electrode, which connected to the cathode of the power source. The anode was connected to a carbon electrode. The current was around 5 mA at a voltage of around 8.5 V. After 1-hour intercalation, the flake was thickened, and the intercalated layers looked dark green. The intercalated molybdenite were cut and ground the pieces into small flakes with a glass rod. 900 mg polyvinylpyrrolidone (PVP) was dissolved into 50 mL dimethylformamide (DMF) and mixed the intercalated molybdenite into it. Next, the mixture was ultrasonicated for 1 hr. The whole solution looked dark green with small shining flakes.

The mixture was centrifuged under 12100 rpm (9985 g, with g as the gravitational acceleration on earth) for 15 min to remove DMF. After that, the clear upper solution was poured out and 40 mL of isopropyl alcohol (IPA) was added. The mixture was ultrasonicated for a second time until no sediment was visible. This process was repeated two more times to fully remove DMF. To concentrate the solution, it was centrifuged under 12100 rpm for 20 min, then added 5 to 10 mL IPA (depending on the amount of intercalated flakes). The ink was ultrasonicated until there was no sediment.

The ink concentration was calibrated by dissolving 20 μL ink into 1 mL IPA and measuring the UV-vis absorption (Beckman Coulter DU800 spectrophotometer). The peak should be around 380 nm with an absorption of around 1.7 for repeatable ink concentration. Finally, the calibrated ink was centrifuged at 3000 rpm (2500 g) for 3 min to remove the remaining large flakes. This process was repeated five times, after which the ink is ready for use.

Device fabrication. Microscope slides were used as the transparent glass substrate. The substrate was first treated with oxygen plasma and becomes hydrophilic. The MoS₂ ink was spin-coated on the substrate at 2000 rpm for 30 s on a spinner. The spin-coating was repeated six times to achieve a film thickness of around 10 nm. It should be appreciated that various thicknesses may be used. (e.g., between 4 nm to 15 nm). The MoS₂ VDWTF was then annealed in a furnace at 400° C. for an hour in an Ar atmosphere.

Next, the MoS₂ channel 20 was patterned and defined the TPT pixels as discussed in the paper. HMDS was evaporated on the sample for improved surface adhesion, then spin-coated SU-8 2005 photoresist on the device at 2000 rpm for 30 sec. The photoresist was pre-baked at 65° C. for 3 min, 95° C. for 3 min, and then 65° C. for 2 min, with the slow temperature change to reduce internal strain and peeling-off. Next, the SU-8 layer 30 was exposed with lithography (Karl Suss MA6) for 20 s to crosslink the polymer. A post-bake process identical to the pre-bake was conducted before developing with SU-8 developer for 30 seconds. The developed sample was rinsed with IPA. The lithography process opened windows on the external contact pads and the via region 32 for connecting the TPT 14 to the ITO electrode 26 on top. After the development, the sample was further annealed at 150° C. in Ar for 30 min, with slow increase and decrease of temperature to avoid SU-8 peeling. This further annealing improves the SU-8 crosslinking and makes it more robust to subsequent thermal and liquid processes. The SU-8 layer 30 thickness was 8 μm measured by a surface profiler. It serves as a passivation for the TPT layer, as well as a thick insulating layer that reduces the parasitic capacitance between TPT 14 and the top ITO pad 26.

Next, a 50-nm ITO layer was sputtered on the top of the sample. Sputtered ITO has good step coverage, sufficient to connect the bottom metal pad to the upper electrode area over the SU-8 step. The ITO was then patterned with lithography and wet etched with 1% hydrochloric acid to make the ITO pads 26 electrically insulated from each other.

The PVA alignment layer 34 was prepared by first dissolving 5% weight of PVA (Sigma Aldrich, molecular weight 89,000-98,000) powder in 95° C. deionized water. The solution was stirred until transparent. Then the solution was spin-coated (3000 rpm, 60 s) on the sample, and another glass slide with an ITO electrode 24 as the top LC contact. The coated sample is annealed at 55° C. for two hours to remove water from the polymer.

Next, an electron-beam evaporator was used to deposit ~2 nm SiO₂ on top of the PVA layer. Specifically, the substrate was tilted to 80° with respect to the normal deposition plane. The high-angle deposition creates nanoscale structures used to align the liquid crystal. Glass microbeads at the diameter of 4.3 μm were dispersed in IPA (10 mg/L, ultrasonicated for an hour) and spin-coated (4000 rpm, 40 s) on the alignment layer 36 as LC spacers. A drop of liquid crystal, 4-cyano-4′-pentylbiphenyl (5 CB) from Sigma Aldrich, was added to the chip. Then the sample is overlapped with the top ITO glass slide 25 with a PVA alignment layer 36 on it. The edges of the two glass slides were sealed with epoxy. Large metal pads stretching out of the sealing region were fabricated (FIG. 1A) and used to apply the supply voltage V_{dd}.

Transmission characterizations. The LC cell 22 without the TPT layer was characterized for selecting the operation conditions. A 1 cm×1 cm large uniform device was illuminated with a thermal lamp and measured the transmitted illuminance with a lux meter. An unstable threshold shift was observed for DC voltage, which is related to ion and water contamination of the LC cell 22, so mobile ions can flow inside the LC and partially screen the modulation electrical field. To enable stable, repeatable LC modulation performance, a rapidly changing square wave was used at 500 Hz to modulate the LC cell 22 (and also for the V_{dd} in TPT-LC stack measurements, with V_{dd} representing the peak-to-peak voltage). The AC field is too fast to cause slow contamination ion drift in LC, but is still sufficient to align the liquid crystal. The same AC measurement scheme was applied to the measurements in FIGS. 3A-3D and FIGS. 4A-4F. The measurement result of the pure LC modulator is shown in FIGS. 8A-8B.

The transmission ratios were calculated as the ratio between the transmissions at the specific test condition (Iₜₑₛₜ) over the reference high transmission at V_{dd}=0 V under weak light (I_{ON}), as reported in FIGS. 3A-3D captions:

$${T}_{R} = \frac{{I}_{test}}{{I}_{ON}}$$

such that I_{ON} was measured at V_{dd}=0. The only exceptions for this are FIG. 3B, when the two polarizers 38, 40 are parallel and the transmission is low at 0 V; for that case, the reference high transmission I_{ON} was defined as the transmission at a very high voltage under weak light, i.e., V_{dd}=16 V was used. The tested device's transmittance already converges to a maximized constant below this voltage for parallel polarizers, indicating it as a feasible definition of the reference high transmission for the parallel polarizer configuration.

The change in phase was also studied with a polarization and phase-sensitive spectroscopy method, with an extra 90° rotation in the transmission matrix due to the twisted LC. The extracted parameters are used to calculate the slight phase modulation accompanying the amplitude modulation, as shown in FIG. 8B. The phase modulation is relatively weak, at around 0.06 rad/V.

Light source quantification. The thermal lamp and the white LED were measured with a spectroscopy system (Horiba Scientific). The light was fed into the system through the objective lens and filtered by the grating system to resolve the spectra. The thermal lamp was kept at a fixed power during these measurements and the nonlinear transmission tests. An attenuator was applied to control the intensity projected on the sample during the transmission test. This avoids possible spectral shifts when the thermal lamp filament is at different temperatures. The luminous efficiency of the lamp was calculated by integrating spectrally resolved luminous efficiency with the lamp spectrum. The photonic luminous efficiency is 68 lm/W. The result is comparable with the previously reported values: black body spectrum at 4000 K peaks at 700 nm and has a luminous efficiency of 55 lm/W. The lamp spectrum also peaks around 700 nm but has a much smaller infrared tail, probably due to infrared absorption on the chamber walls of the torch, leading to a higher luminous efficiency than the 4000 K black body radiation. The white LED has a luminous efficiency of 200 lm/W.

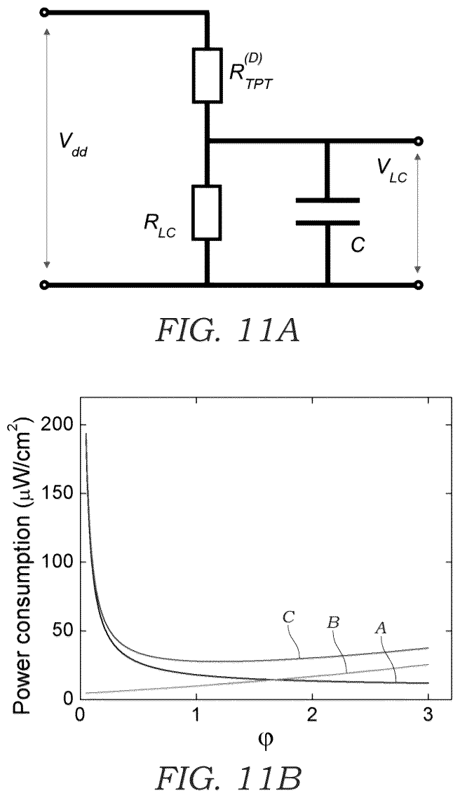

Photo response measurements. The photo response at 633 nm and 488 nm was measured with the Horiba Raman spectroscopy system. The CCD camera in the Horiba system was used to adjust the laser spot size and overlap it with the device pixel 12. The incident powers on the optoelectronic neuron array 10 were calibrated with a power meter placed under the objective lens. The device uniformity (FIG. 2F) was estimated over 116 devices that are fabricated on four chips with identical process flow and separately wired out. On each chip, 29 devices were tested, spanning an area of 14 mm×10 mm surrounding the arrayed TPTs 14. The light resistances were measured under a thermal lamp at an illuminance of 1.4×10⁴ lux. The thermal lamp spectrum is shown in FIG. 10, with a center wavelength of 713 nm and a full-width-at-half-maximum (FWHM) bandwidth of 175 nm.

Glare reduction analysis. The image quality was evaluated with and without glare reduction in the five boxes shown in FIG. 4B. The image in each box was transformed into a 80×50 matrix (Mⱼₖ) by summing up the RGB values. The mean intensity of the N=50 image pixels is calculated along the direction of the grating lines to evaluate the averaged pattern (Īⱼ):

$${\overline{I}}_{j} = \frac{1}{N} {\sum }_{k = 1}^{N} {M}_{jk} \qquad ( Eq . 1 )$$

This vector, Īⱼ, is plotted with solid lines in FIGS. 4B-4F. The corrected sample standard deviations (sⱼ) along the 100 image pixels were also evaluated for each column and plotted as the error bars in FIGS. 4B=4F:

$${s}_{j} = \sqrt{\frac{1}{N - 1} {\sum }_{k = 1}^{N} {( {M}_{jk} - {\overline{I}}_{j} )}^{2}} \qquad ( Eq . 2 )$$

$$j = 1 , 2 , … , 80 ; N = 100$$

The image signal was defined as the difference between the average intensity in the bright region (R_{bright}, with N_{bright} pixels) and the dark region (R_{dark}, with N_{dark} pixels) of the grating lines. The bright/dark regions were selected as the pixels with the top/bottom 25% intensities in the dynamic range, which was defined by the maximum intensity minus the minimum intensity in the box. The bright/dark regions were only segmented once using the no-glare image in FIG. 4B, and applied to all subsequent SNR evaluations at different glare, voltage, and exposure settings. The SNR was calculated as the ratio of the signal over the standard deviation in the dark regions:

$${\overline{I}}_{bright} = \frac{1}{{N}_{bright}} {\sum }_{jk ∈ {R}_{bright}} {M}_{jk} \qquad ( Eq . 3 )$$

$${\overline{I}}_{dark} = \frac{1}{{N}_{dark}} {\sum }_{jk ∈ {R}_{dark}} {M}_{jk} \qquad ( Eq . 4 )$$

$$SNR = \frac{{\overline{I}}_{bright} - {\overline{I}}_{dark}}{σ} \qquad ( Eq . 5 )$$

σ is the corrected sample standard deviation of all the data points within the dark regions in the box:

$$σ = \sqrt{\frac{1}{{N}_{dark} - 1} {\sum }_{jk ∈ {R}_{dark}} {( {M}_{jk} - {\overline{I}}_{dark} )}^{2}} \qquad ( Eq . 6 )$$

where N_{dark} is the total number of image data points in the dark regions of the grating lines.

The pattern contrast C is evaluated as below:

$$C = \frac{{\overline{I}}_{bright} - {\overline{I}}_{dark}}{( {\overline{I}}_{bright} - {\overline{I}}_{dark} ) / 2} \qquad ( Eq . 7 )$$

The temporal evolutions of intensity in FIGS. 5A-5F were evaluated with summed RGB values over the displayed region (solid lines in the curves) and region marked by the rectangle region in FIG. 5A.

### Supplementary Note 1.

First, a few basic parameters of the TPT-LC system are set with the experimental data. Material level optimizations may significantly improve the device performance beyond the calculated results based on the experimental parameters, which will not be discussed. TPT-free, large-area LC modulators were tested with identical process flow to the optoelectronic neurons. At the threshold voltage Vₜₕ=3 V, the current density is J=3 μA/cm². Next, the TPT-LC stack was tested and observed an averaged V_{dd}=6 V for the LC layer to enter the threshold. As a result, one can derive the average TPT resistance at a weak intensity from:

$${V}_{LC} = \frac{{R}_{LC}}{{R}_{TPT}^{( D )} + {R}_{LC}} {V}_{dd} \qquad ( Eq . S 1 )$$

The LC resistance per pixel (100 μm by 100 μm for the experimental devices) is R_{LC}=3 V/3 μA×10⁴=10 GQ. The dark resistance of the square MoS₂ channel is then

$${R}_{TPT}^{( D )} = 10 G Ω .$$

The capacitance of the liquid crystal is calculated with the permittivity of 5CB (εᵣ≈18¹) and PVA (ε≈2, slightly varies depending on sample preparation conditions²), with the thickness of PVA around 1 μm for both the upper and lower LC alignment layers. The ultimate capacitance is majorly limited by the lower-permittivity PVA layers and is around 0.71 nF/cm².

The equivalent RC circuit for a TPT-LC pixel is shown in FIG. 11A. The LC driving voltage is related to the frequency following the equation:

$${V}_{LC} = {V}_{dd} \frac{\frac{{R}_{LC}}{1 + j ω {CR}_{LC}}}{{R}_{TPT}^{( D )} + \frac{{R}_{LC}}{1 + j ω {CR}_{LC}}} = {V}_{dd} \frac{{R}_{LC}}{{R}_{TPT}^{( D )} + {R}_{LC}} \frac{1}{1 + j ω C \frac{{R}_{LC} {R}_{TPT}^{( D )}}{{R}_{LC} + {R}_{TPT}^{( D )}}} \qquad ( Eq . S 2 )$$

The dark resistance of the TPT 14 was applied,

$${R}_{TPT}^{( D )} ,$$

above since it gives the lower bound of the cutoff frequency compared with the light resistance. The 3 dB cutoff frequency is then:

$${f}_{3 db} = {\frac{1}{2 π} [ C \frac{{R}_{LC} {R}_{TPT}^{( D )}}{{R}_{LC} + {R}_{TPT}^{( D )}} ]}^{- 1} \qquad ( Eq . S3 )$$

Take the experimental values of the devices, f₃ dB=452 Hz. This RC delay, together with the intrinsic response time of LC molecules, limits the device response to a few hundred hertz. At the same time, the TPT layer can operate beyond kHz frequencies, and can be heterogeneously integrated with other types of modulators for higher operation speed.

Next, the scaling laws of the device are discussed. Since the two sources of power consumption, the photon absorption and the electrical power consumption, are both fixed with the total array area, increasing the number of pixels per area (N) will result in a reduction in the power consumption per activation proportional to N⁻1. On the other hand, the product of C·R_{LC} remains constant during the scaling down, so the speed of the device remains constant as long as the TPT resistance increases accordingly. The TPT resistance can be well controlled by orders of magnitudes with changed channel geometry, annealing, and electrostatic gating for the VDWTF phototransistors. Considering the thickness of the LC modulation layer, edge effects of electric fields between parallel capacitors will become nontrivial when the pixel size is below 5 μm for the current design. However, it is possible to reduce the LC thickness to sub-micrometers, so that the pixel size can go below 1 μm^{Error!} Bookmark not defined. Here the ultimate power consumption per pixel based on a 5-μm device size is estimated. This avoids imprecise estimations when the LC cell 22 resistance changes with a thinner LC layer thickness.

The static electrical power consumption of the optoelectronic neurons is:

$${P}_{elec} = {V}_{dd} {I}_{total} = \frac{{R}_{TPT}^{( D )} + {R}_{LC}}{{R}_{LC}} {V}_{th} {I}_{total} \qquad ( Eq . S4 )$$

The dynamic charging effect consumes a varied power depending on the input intensity change. Suppose the intensity changes are perfectly balanced in total power over all pixels 12. In that case, the dynamic charging is balanced on the common electrodes, contributing to no additional power consumption. On the contrary, if the whole array 10 is suddenly uniformly illuminated, the dynamic charging cannot be balanced and consumes the energy W_{dynamic} per charging:

$${W}_{dynamic} = {V}_{dd} {I}_{charging} Δ t = {V}_{dd} Δ Q = {C V}_{dd} Δ {V}_{LC} \qquad ( Eq . S5 )$$

ΔV_{LC}~2 V is the voltage change to switch the LC from ON to OFF in the unoptimized LC modulators. Considering the worst case of uniform charging and discharging at the operation frequency f=100 Hz, this leads to the maximum possible dynamic charging power:

$${P}_{dynamic}^{( max )} = \frac{1}{2} {C V}_{dd} Δ {V}_{LC} f \qquad ( Eq . S6 )$$

The factor of

$$\frac{1}{2}$$

comes from charging and discharging per alternate cycles at 100 Hz. The value is 0.4 μW/cm² for the experimental device, which is much smaller than the static power consumption of 18 μW/cm² (Eq. S4) with the worst-case estimation.

Statistically, the dynamic charging power is proportional to the fluctuation of the total charging current I_{charging} of all the pixels 12. Suppose the illumination on Nₚᵢₓ pixels are independent and fluctuate randomly, the total current fluctuation scales with 1/\sqrt{Nₚᵢₓ}. Consequently, the mean dynamic charging power with Nₚᵢₓ pixels in the whole array is:

$${P}_{dynamic}^{( mean )} = \frac{{C V}_{dd} Δ {V}_{LC} f}{2 \sqrt{{N}_{pix}}} \qquad ( Eq . S7 )$$

For the optoelectronic neuron array 10 with 10,000 pixels, the value is 4 nW/cm² and negligible compared to the static electrical power consumption.

As discussed herein, the modulation from a high-transmission state to a low-transmission state can be achieved in ΔV_{LC}=0.3 V with optimized LC modulator structures. This can help us reduce the incidental intensity to trigger optoelectronic nonlinearity. The voltage change in LC is related to the TPT resistance change by:

$$Δ {V}_{LC} = ( \frac{{R}_{LC}}{{R}_{TPT}^{( L )} + {R}_{LC}} - \frac{{R}_{LC}}{{R}_{TPT}^{( D )} + {R}_{LC}} ) {V}_{dd} = ( \frac{{R}_{TPT}^{( D )} + {R}_{LC}}{{R}_{TPT}^{( L )} + {R}_{LC}} - 1 ) {V}_{th} \qquad ( Eq . S8 )$$

The TPT resistances at different intensity levels are experimentally available with photocurrent measurements at the wavelength of 633 nm, as shown in FIG. 2D. If one assumes a linear relation between the total channel current I_{ds} and the incident power P_{inc}:

$${I}_{ds}^{( L )} = ( 1 + α {P}_{inc} ) {I}_{ds}^{( D )} \qquad ( Eq . S9 )$$

A conservative estimation of weak-light photo response is adopted, assuming that the responsivity is constant below the lowest experimental illumination of 0.7 mW/cm². The assumption leads to a lower bound of the responsivity factor α=4.46, with P_{inc} having a unit of mW/cm². The actual responsivity at lower optical powers may exceed the fitted value, as defect saturation effects are much weaker under lower power illuminations. As a result, the presented estimation provides an upper bound of the necessary optical power for producing sufficient nonlinearity.

Take together Eq. S8 and Eq. S9, one has:

$${( 1 + α {P}_{inc} )}^{- 1} = {( 1 + γ )}^{- 1} - \frac{γφ}{1 + γ} \qquad ( Eq . S10 )$$

$$γ = \frac{Δ {V}_{LC}}{{V}_{th}} and φ = \frac{{R}_{LC}}{{R}_{PD}^{( D )}}$$

are dimensionless parameters for brevity.

Consequently, the minimum necessary intensity is given by:

$${P}_{inc} = \frac{γ ( 1 + φ )}{α ( 1 - γφ )} ( in mW / {cm}^{2} ) \qquad ( Eq . S11 )$$

Taken the estimated parameter from the experimental devices,

$$γ = \frac{2 V}{3 V} = 0.67$$

and φ=1, P_{inc}=0.91 mW/cm². The threshold matches in its order of magnitude with the experimental device when operated at 8 V bias. For the potentially optimized devices with

$$γ = \frac{0.3 V}{3 V} = 0.1$$

and φ=1.19 (from the optimized device with minimized total power consumption), one would have P_{inc}=56 μW/cm², much smaller than the unoptimized devices.

The total power consumption of the ideal device is:

$${P}_{total} = \frac{1 + φ}{φ} {V}_{th} {I}_{total} + A \frac{γ ( 1 + φ )}{α ( 1 - γφ )} \qquad ( Eq . S12 )$$

A=0.2 is the photon loss through the TPT layer. Picking a larger φ value favors a smaller electrical power consumption, as a smaller V_{dd} is necessary to drive the device. However, it results in a larger optical intensity to create a larger TPT resistance change that shuts off the LC modulator. The minimum power consumption is 27.7 μW/cm² at φ=1.19. Considering a scaled-down pixel size of 5 μm, the power consumption is 6.9 pW/pixel. Following Eq. S5 and S7, with Nₚᵢₓ=4×10⁶ at 1 cm² total array area,

$${P}_{dynamic}^{( max )} = 55 nW / {cm}^{2} , and {P}_{dynamic}^{( mean )} = 28 pW / {cm}^{2} ,$$

which are much smaller than the static power. Hence, the dynamic charging power is again negligible. Finally, with an operation frequency of 100 Hz, the device can perform a nonlinear optical calculation at 69 fJ per activation.

While the TPTs 14 have been described herein as 2D TPTs 14 it should be appreciated that the TPT 14 does not necessarily have to be 2D in all embodiments. Three-dimensional (3D) TPTs 14 made with other conventional semiconductors, such as Si, III-V compound semiconductors, and organic semiconductors, etc., may also be used as part of the optoelectronic neuron array 10 if proper material and structural engineering enables good transparency and photoresponse. 2D TPTs 14 were preferred as it was easier to maintain the photo response but 3D TPTs 14 may also be used. In addition, while MoS₂ is described as the preferred material for the channel 20, it should be understood that other 2D transition metal dichalcogenides (TMDs) such as molybdenum diselenide (MoSez), tungsten disulfide (WS₂), and tungsten diselenide (WSe₂) may be used.

While embodiments of the present invention have been shown and described, various modifications may be made without departing from the scope of the present invention. In some embodiments, alternatives to ITO may be used for the top and intermediate electrodes. For example, graphene-based materials may be used. The invention, therefore, should not be limited, except to the following claims, and their equivalents.

1. An optoelectronic neuron array for nonlinear optical modulation comprising an array of pixels, each pixel comprising:
a two-dimensional transparent phototransistor (TPT) comprising a source electrode, a drain electrode, and a channel;
an intermediate optically transparent electrode;
a liquid crystal (LC) cell disposed adjacent to the TPT and including an optically transparent ground electrode at one end thereof, wherein the intermediate optically transparent electrode is interposed between the TPT and the LC cell; and
wherein the source electrode is electrically connected to the intermediate optically transparent electrode and wherein the drain electrode is electrically connected to a supply voltage (V_{dd}).

2. The optoelectronic neuron array of claim 1, wherein the TPT and the LC cell are secured to respective optically transparent substrate layers.

3. The optoelectronic neuron array of claim 1, further comprising an optically transparent insulating layer between the channel and the intermediate optically transparent electrode and an electrically conductive via disposed therein electrically connecting the source electrode to the intermediate optically transparent electrode.

4. The optoelectronic neuron array of claim 1, wherein the LC cell comprises a first alignment layer and a second alignment layer, wherein the second alignment layer is oriented generally orthogonal to the first alignment layer.

5. The optoelectronic neuron array of claim 1, further comprising a first polarizer disposed on or adjacent to the TPT and a second polarizer disposed on or adjacent to the LC cell.

6. The optoelectronic neuron array of claim 5, wherein the first polarizer and the second polarizer are oriented generally orthogonal with respect to each other.

7. The optoelectronic neuron array of claim 5, wherein the first polarizer and the second polarizer are oriented generally parallel with respect to each other.

8. The optoelectronic neuron array of claim 1, wherein the optoelectronic neuron array is interposed along an optical path of a camera, a microscope, an optical processor, or an imaging device.

9. The optoelectronic neuron array of claim 1, wherein the intermediate optically transparent electrode and the optically transparent ground electrode comprise indium tin oxide (ITO).

10. The optoelectronic neuron array of claim 1, wherein the channel comprises molybdenum disulfide (MoS₂).

11. The optoelectronic neuron array of claim 1, further comprising one or more optically transmissive and/or reflective substrate layer(s) arranged in an optical path with the optoelectronic neuron array, each of the optically transmissive and/or reflective substrate layer(s) comprising a plurality of physical features formed on or within the one or more optically transmissive or reflective substrate layer(s) and having different transmission and/or reflection properties as a function of the lateral coordinates across each substrate layer, wherein the one or more optically transmissive and/or reflective substrate layer(s) arrays collectively process and/or extract and/or reject object and/or scene information from an input image input to the optically transmissive and/or reflective substrate layer(s).

12. The optoelectronic neuron array of claim 11, further comprising one or more lenses or lens sets disposed along the optical path.

13. The optoelectronic neuron array of claim 11, further comprising an image sensor or one or more optical detectors disposed along an optical path and configured to receive an output of the optoelectronic neuron array.

14. A method of performing nonlinear modulation of broadband, incoherent light comprising:
providing an optoelectronic neuron array for nonlinear optical modulation comprising an array of pixels, each pixel comprising a two-dimensional transparent phototransistor (TPT) comprising a source electrode, a drain electrode, and a channel; an intermediate optically transparent electrode; a liquid crystal (LC) cell disposed adjacent to the TPT and including an optically transparent ground electrode at one end thereof, wherein the intermediate optically transparent electrode is interposed between the TPT and the LC cell; and wherein the source electrode is electrically connected to the intermediate optically transparent electrode and wherein the drain electrode is electrically connected to a supply voltage (V_{dd}); and
inputting the broadband, incoherent light into the optoelectronic neuron array.

15. The method of claim 14, further comprises capturing an output of the optoelectronic neuron array with a camera, a microscope, an optical processor, or imaging device.

16. The method of claim 14, wherein the broadband, incoherent light comprises ambient light.

17. The method of claim 14, further comprising providing one or more optically transmissive and/or reflective substrate layer(s) arranged in an optical path with the optoelectronic neuron array, each of the optically transmissive and/or reflective substrate layer(s) comprising a plurality of physical features formed on or within the one or more optically transmissive or reflective substrate layer(s) and having different transmission and/or reflection properties as a function of the lateral coordinates across each substrate layer, wherein the one or more optically transmissive and/or reflective substrate layer(s) arrays collectively process and/or extract and/or reject object and/or scene information from an input image input to the optically transmissive and/or reflective substrate layer(s).
